(19) United States
(12) Patent Application Publication
(10) Pub. No.: US 2016/0258133 A1
(43) Pub. Date: Sep. 8, 2016

(54) HYDRAULIC DRIVE SYSTEM FOR CONSTRUCTION MACHINE

(71) Applicant: Hitachi Construction Machinery Co., Ltd., Tokyo (JP)

(72) Inventors: Yasutaka TSURUGA, Ryuugasaki-shi (JP); Kiwamu TAKAHASHI, Moriyama-shi (JP); Yasuharu OKAZAKI, Namerikawa-shi (JP); Hiroyuki NOBEZAWA, Takaoka-shi (JP); Kenji YAMADA, Toyama-shi (JP)

(73) Assignee: Hitachi Construction Machinery Co., Ltd., Tokyo (JP)

(21) Appl. No.: 15/027,016

(22) PCT Filed: Nov. 26, 2014
(86) PCT No.: PCT/JP2014/081146

§ 371 Date: Apr. 4, 2016

(30) Foreign Application Priority Data
Nov. 28, 2013 (JP) 2013-246803

(51) Int. Cl. E02F 9/22; F15B 13/08; F15B 13/02; F15B 11/17

(52) U.S. Cl. CPC E02F 9/2235; F15B 11/17; F15B 13/0803; F15B 13/026; F15B 13/025; E02F 9/2267; E02F 9/2292; E02F 9/2296; E02F 9/2228; F15B 2211/20546; F15B 2211/25; F15B 2211/20576; E02F 3/325

(57) ABSTRACT

It is an object of the present invention to accurately detect the absorption torque of the other of two hydraulic pumps by a purely hydraulic structure and feed the absorption torque to one of the two hydraulic pumps, thereby to accurately perform a total torque control, effectively utilize a rated output torque of a prime mover, and enhance mountability. To achieve the object, there are provided: a torque feedback circuit 31 to which the delivery pressure of a first hydraulic pump 1a and a load sensing drive pressure are introduced, which modifies the delivery pressure of a second hydraulic pump 1b to provide a characteristic simulating the absorption torque of the second hydraulic pump 1b, and which outputs the modified pressure; and torque feedback pistons 32a, 32b to which the output pressure of the torque feedback circuit 31 is introduced, and which control the capacity of the first hydraulic pump 1a to decrease the capacity of the first hydraulic pump 1a and decrease a maximum torque T1max as the output pressure becomes higher. The torque feedback circuit 31 includes pressure dividing restrictor parts 34a, 34b, pressure dividing valves 35a, 35b, and relief valves 37a, 37b.

### TECHNICAL FIELD

The present invention relates to a hydraulic drive system for a construction machine such as hydraulic excavator. Particularly, the invention relates to a hydraulic drive system for a construction machine that includes at least two variable displacement hydraulic pumps, one of which has a pump control unit (regulator) performing at least a torque control and the other of which has a pump control unit (regulator) performing a load sensing control and a torque control.

### BACKGROUND ART

As a hydraulic drive system for a construction machine such as hydraulic excavator, one having a regulator that controls the capacity (flow rate) of a hydraulic pump in such a manner that the delivery pressure of the hydraulic pump becomes higher than a maximum load pressure of a plurality of actuators by a target differential pressure is widely used, and this is called load sensing control. Patent Document 1 describes a two-pump load sensing system in a hydraulic drive system for a construction machine provided with a regulator for performing such a load sensing control, in which two hydraulic pumps are provided, and the respective two hydraulic pumps perform the load sensing control.

Besides, in a regulator of a hydraulic drive system for a construction machine, normally, a torque control is conducted such that the absorption torque of a hydraulic pump does not exceed a rated output torque of a prime mover, by decreasing the capacity of the hydraulic pump as the delivery pressure of the hydraulic pump rises, thereby to prevent stoppage of the prime mover (engine stall) due to an overtorque. In the case where the hydraulic drive system is provided with two hydraulic pumps, the regulator of one hydraulic pump performs a torque control (total torque control) by using not only its own delivery pressure but also a parameter concerning the absorption torque of the other hydraulic pump, thereby to attain both prevention of stoppage of the prime mover and effective utilization of a rated output torque of the prime mover.

For instance, in Patent Document 2, a total torque control is carried out by introducing the delivery pressure of one of the two hydraulic pumps to the regulator of the other hydraulic pump through a pressure reduction valve. A set pressure of the pressure reduction valve is fixed, and this set pressure is set at a value simulating a maximum torque in the torque control of the regulator of the other hydraulic pump. This ensures that in an operation of driving only the actuators concerning the one hydraulic pump, the one hydraulic pump can effectively use substantially the whole of the rated output torque of the prime mover, and, in a combined operation of simultaneously driving the actuators concerning the other hydraulic pump, the absorption torque of the whole of the pumps does not exceed the rated output torque of the prime mover, so that stoppage of the prime mover can be prevented from occurring.

In Patent Document 3, in order to carry out a total torque control for two variable displacement hydraulic pumps, the tilting angle of the other hydraulic pump is detected as an output pressure of a pressure reduction valve, and the output pressure is introduced to the regulator of the one hydraulic pump. In Patent Document 4, control accuracy of a total torque control is enhanced by detecting the tilting angle of the other hydraulic pump by replacing the tilting angle with the arm length of an oscillating arm.

### PRIOR ART DOCUMENTS

### Patent Documents

Patent Document 1: JP-2011-196438-A

Patent Document 2: Japanese Patent No. 3865590

Patent Document 3: JP-1991-7030-B

Patent Document 4: JP-1995-189916-A

### SUMMARY OF THE INVENTION

### Problem to be Solved by the Invention

By applying the technology of the total torque control described in Patent Document 2 to the two-pump load sensing system described in Patent Document 1, it is possible to perform a total torque control also in the two-pump load sensing system described in Patent Document 1. In the total torque control of Patent Document 2, however, the set pressure of the pressure reduction valve is set at a fixed value simulating the maximum torque for the torque control of the other hydraulic pump, as aforementioned. Therefore, in a combined operation of simultaneously driving the actuators concerning the two hydraulic pumps, when the other hydraulic pump is in such an operating state that the other hydraulic pump is limited by the torque control and operates at the maximum torque for the torque control, it is possible to contrive effective utilization of a rated output torque of the prime mover. However, when the other hydraulic pump is in such an operating state that the other hydraulic pump is not limited by the torque control and performs a capacity control by the load sensing control, there occurs the following problem: notwithstanding the absorption torque of the other hydraulic pump being smaller than the maximum torque for the torque control, the output pressure of the pressure reduction valve simulating the maximum torque is introduced to the one regulator of the hydraulic pump, and a control such as to decrease the absorption torque of the one hydraulic pump more than necessary would be performed. Consequently, it has been impossible to accurately perform the total torque control.

In Patent Document 3, it is attempted to enhance the accuracy of the total torque control, by detecting the tilting angle of the other hydraulic pump as the output pressure of the pressure reduction valve and introducing the output pressure to the regulator of the one hydraulic pump. However, there occurs a problem. In general, the torque of a pump is determined as the product of delivery pressure and capacity, specifically, (delivery pressure×pump capacity)/2π. On the other hand, in Patent Document 3, the delivery pressure of the one hydraulic pump is introduced to one of two pilot chambers of a stepped piston, whereas the output pressure of the pressure reduction valve (the delivery amount proportional pressure for the other hydraulic pump) is introduced to the other pilot chamber of the stepped piston, and the capacity of the one hydraulic pump is controlled using the sum of the delivery pressure and the delivery amount proportional pressure as a parameter of the output torque. Consequently, there would be generated a considerable error between the parameter and the torque being actually used.

In Patent Document 4, the control accuracy of the total torque control is enhanced by detecting the tilting angle of the other hydraulic pump by replacing the tilting angle with the arm length of an oscillating arm. However, the regulator in Patent Document 4 has a very complicated structure in which the oscillating arm and a piston provided in a regulator piston structure are slid relative to each other while transmitting a force. To provide a sufficiently durable structure, therefore, it is necessary to cause parts such as the oscillating arm and the regulator piston to be rigid, which makes it difficult to miniaturize the regulator. Particularly, in the small-type hydraulic excavator such as so-called rear small swing type having a small rear end radius, there have been the cases where the space for accommodating the hydraulic pump is so small that it is difficult to mount the hydraulic pump.

It is an object of the present invention to provide a hydraulic drive system for a construction machine that is provided with two variable displacement hydraulic pumps, one having a pump control unit to perform at least a torque control and the other performing a load sensing control and a torque control, in which the absorption torque of the other hydraulic pump is accurately detected by a purely hydraulic structure and fed back to the one hydraulic pump side, whereby it is possible to accurately carry out the total torque control, effectively utilize a rated output torque of a prime mover, and enhance mountability.

### Means for Solving the Problem

(1) To achieve the above object, the present invention provides a hydraulic drive system for a construction machine, including: a prime mover; a variable displacement first hydraulic pump driven by the prime mover; a variable displacement second hydraulic pump driven by the prime mover; a plurality of actuators driven by hydraulic fluids delivered by the first and second hydraulic pumps; a plurality of flow control valves that control flow rates of hydraulic fluids supplied from the first and second hydraulic pumps to the plurality of actuators; a plurality of pressure compensating valves that control differential pressures across the plurality of flow control valves; a first pump control unit that controls a delivery flow rate of the first hydraulic pump; and a second pump control unit that controls a delivery flow rate of the second hydraulic pump, the first pump control unit including a first torque control section that, when at least one of delivery pressure and capacity of the first hydraulic pump increases and absorption torque of the first hydraulic pump increases, controls the capacity of the first hydraulic pump such that the absorption torque of the first hydraulic pump does not exceed a first maximum torque, the second pump control unit including a second torque control section that, when at least one of delivery pressure and capacity of the second hydraulic pump increases and absorption torque of the second hydraulic pump increases, controls the capacity of the second hydraulic pump such that the absorption torque of the second hydraulic pump does not exceed a second maximum torque, and a load sensing control section that, when the absorption torque of the second hydraulic pump is lower than the second maximum torque, controls the capacity of the second hydraulic pump such that the delivery pressure of the second hydraulic pump becomes higher by a target differential pressure than a maximum load pressure of the actuators driven by a hydraulic fluid delivered by the second hydraulic pump, wherein the first torque control section includes a first torque control actuator that receives the delivery pressure of the first hydraulic pump and that, when the delivery pressure rises, controls the capacity of the first hydraulic pump to decrease the capacity of the second hydraulic pump and decrease the absorption torque thereof, and first biasing means that sets the first maximum torque, the second torque control section includes a second torque actuator that receives the delivery pressure of the second hydraulic pump and, when the delivery pressure rises, controls the capacity of the second hydraulic pump to decrease the capacity of the second hydraulic pump and decrease the absorption torque thereof, and second biasing means that sets the second maximum torque, the load sensing control section includes a control valve that varies a load sensing drive pressure such that the load sensing drive pressure is lowered as a differential pressure between the delivery pressure of the second hydraulic pump and the maximum load pressure becomes smaller than the target differential pressure, and a load sensing control actuator that controls the capacity of the second hydraulic pump to increase the capacity of the second hydraulic pump and increase the delivery flow rate as the load sensing drive pressure becomes lower, the first pump control unit further includes a torque feedback circuit that receives the delivery pressure of the second hydraulic pump and the load sensing drive pressure and modifies the delivery pressure of the second hydraulic pump based on the delivery pressure of the second hydraulic pump and the load sensing drive pressure to provide a characteristic simulating the absorption torque of the second hydraulic pump both in the cases of when the second hydraulic pump is limited by control of the second torque control section and operates at the second maximum torque and when the second hydraulic pump is not limited by control of the second torque control section and the load sensing control section controls the capacity of the second hydraulic pump, and then outputs the modified delivery pressure as a torque control pressure, and a third torque control actuator that receives the torque control pressure and controls the capacity of the first hydraulic pump to decrease the capacity of the first hydraulic pump and decrease the first maximum torque as the torque control pressure becomes higher, the torque feedback circuit includes a fixed restrictor that receives the delivery pressure of the second hydraulic pump, a variable restrictor valve located on a downstream side of the fixed restrictor and connected to a tank in the downstream side thereof, and a pressure limiting valve connected to a hydraulic line between the fixed restrictor and the variable restrictor valve to control the pressure in the hydraulic line such that the pressure does not increase beyond a pressure that initiates the control of the second torque control section, the variable restrictor valve is configured such that the variable restrictor valve is fully closed when the load sensing drive pressure is at a lowest pressure and that the opening area of the variable restrictor valve increases as the load sensing drive pressure rises, and the torque feedback circuit generates the torque control pressure based on the pressure in the hydraulic line between the fixed restrictor and the variable restrictor valve, the torque control pressure being introduced to the third torque control actuator.

In the present invention configured as above, when the second hydraulic pump is not limited by control of the second torque control section and the load sensing control section controls the capacity of the second hydraulic pump (when the delivery pressure of the second hydraulic pump is lower than a pressure that initiates the control of the second torque control section), the pressure in the hydraulic line between the fixed restrictor and the variable restrictor valve increases as the delivery pressure of the second hydraulic pump increases, and decreases as the load sensing drive pressure rises. This variation in the pressure is approximate to variation in the absorption torque of the second hydraulic pump that increases as the delivery pressure of the second hydraulic pump increases and that decreases as the load sensing drive pressure rises (the capacity of the second hydraulic pump decreases), in the case when the second hydraulic pump is not limited by the control of the second torque control section and the load sensing control controls the capacity of the second hydraulic pump. In addition, the torque control pressure is generated based on the pressure in the hydraulic line between the fixed restrictor and the variable restrictor valve, and variation in the torque control pressure is also approximate to variation in the absorption torque of the second hydraulic pump. As a result, the absorption torque of the second hydraulic pump can be accurately detected by a purely hydraulic structure, and the torque feedback circuit can modify the delivery pressure of the second hydraulic pump to provide a characteristic simulating the absorption torque of the second hydraulic pump and can output the modified pressure as a torque control pressure.

Besides, the torque control pressure is introduced to the third torque control actuator and the absorption torque of the second hydraulic pump is fed back to the side of the first hydraulic pump (the one hydraulic pump), whereby the first maximum torque set in the first torque control section of the first hydraulic pump can be decreased by the amount of the absorption torque of the second hydraulic pump, both in the cases of when the second hydraulic pump is limited by control of the second torque control section and operates at the second maximum torque and when the second hydraulic pump is not limited by the control of the second torque control section and the load sensing control section controls the capacity of the second hydraulic pump; accordingly, the total torque control can be carried out accurately and a rated output torque of the prime mover can be utilized effectively. In addition, since the absorption torque of the second hydraulic pump is detected on a purely hydraulic structure basis, the first pump control unit can be miniaturized, and mountability is enhanced.

(2) In the above paragraph (1), preferably, the torque feedback circuit further includes a pressure reduction valve that receives the delivery pressure of the second hydraulic pump as a primary pressure, the pressure in the hydraulic line between the fixed restrictor and the variable restrictor valve is introduced to the pressure reduction valve as a target control pressure for providing a set pressure of the pressure reduction valve, and the pressure reduction valve outputs the delivery pressure of the secondary hydraulic pump as a secondary pressure without reduction when the delivery pressure of the second hydraulic pump is lower than the set pressure, and reduces the delivery pressure of the second hydraulic pump to the set pressure and outputs the thus lowered pressure when the delivery pressure of the second hydraulic pump is higher than the set pressure, the output pressure of the pressure reduction valve being introduced to the third torque control actuator as the torque control pressure.

By thus generating the torque control pressure from the delivery pressure of the second hydraulic pump by the pressure reduction valve, it is possible to secure a flow rate at the time of driving the third torque control actuator by the torque control pressure and to improve the responsiveness at the time of driving the third torque control actuator.

In addition, since the pressure in the hydraulic line between the fixed restrictor and the variable restrictor valve is not directly used as the torque control pressure, the setting of the fixed restrictor and the variable restrictor valve for obtaining a required target control pressure and the setting of the responsiveness of the third torque control actuator can be performed independently, and thus the setting of the torque feedback circuit for exhibiting a required performance can be performed easily and accurately.

Further, since fluctuations in the delivery pressure of the second hydraulic pump are blocked by the pressure reduction valve and therefore do not influence the third torque control actuator when the delivery pressure of the second hydraulic pump is higher than the set pressure of the pressure reduction valve, the stability of the system is secured.

(3) In the above paragraph (1) or (2), preferably, the pressure limiting valve is a relief valve.

### Effect of the Invention

According to the present invention, the absorption torque of the second hydraulic pump can be accurately detected by a purely hydraulic structure (torque feedback circuit). Besides, by feeding the absorption torque back to the side of the first hydraulic pump (the one hydraulic pump), it is possible to accurately perform the total torque control and to effectively utilize a rated output torque of the prime mover. In addition, since the absorption torque of the second hydraulic pump is detected on a purely hydraulic basis in this structure, the first pump control unit can be miniaturized, and mountability is enhanced. As a result, it is possible to provide a construction machine that is good in energy efficiency, low in fuel consumption, and is practical.

### BRIEF DESCRIPTION OF DRAWINGS

FIG. 1A is a hydraulic circuit diagram showing the whole part of a hydraulic drive system for a hydraulic excavator (construction machine) according to a first embodiment of the present invention.

FIG. 1B is a hydraulic circuit diagram showing the details of a torque feedback circuit of the hydraulic drive system for the hydraulic excavator (construction machine) according to the first embodiment of the present invention.

FIG. 2 is a block diagram showing the whole part of the hydraulic drive system for the hydraulic excavator (construction machine) according to the first embodiment of the present invention.

FIG. 3 is a diagram showing the relation between LS drive pressure and tilting angle of swash plate of first and second hydraulic pumps when a load sensing control piston operates.

FIG. 4A is a torque control diagram of a first torque control section.

FIG. 4B is a torque control diagram of a second torque control section 13b.

FIG. 5A is a diagram showing the relation between LS drive pressure and opening area of first and second pressure dividing valves.

FIG. 5B is a diagram showing the relation between opening area of the first and second pressure dividing valves and target control pressure.

FIG. 5C is a diagram showing the relation between delivery pressure of third and fourth delivery ports and target control pressure when the LS drive pressure varies.

FIG. 5D is a diagram showing the relation between the delivery pressure of the third and fourth delivery ports and torque control pressure when the LS drive pressure varies.

FIG. 6 is a diagram showing relations between the delivery pressure of the third and fourth delivery ports, torque control pressure and LS drive pressure represented by equation (6) and equation (7).

FIG. 7 is a view showing the external appearance of the hydraulic excavator.

FIG. 8 is a diagram showing a hydraulic system in the case where the technology of total torque control described in Patent Document 2 is incorporated into a two-pump load sensing system including the first and second hydraulic pumps shown in FIG. 1, as a comparative example.

FIG. 9 is a diagram illustrating the total torque control according to the comparative example shown in FIG. 8.

FIG. 10 is a diagram showing a total torque control according to the present embodiment.

### MODES FOR CARRYING OUT THE INVENTION

Embodiments of the present invention will be described below, referring to the drawings.

### —Structure—

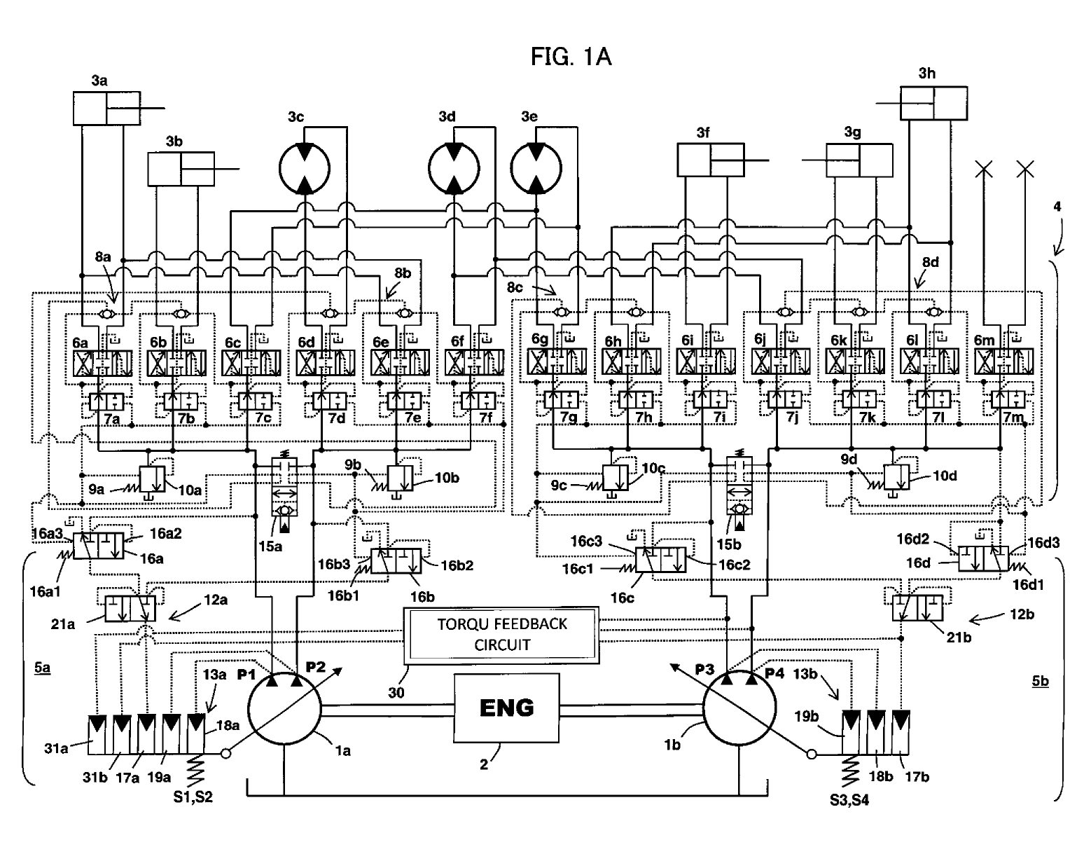

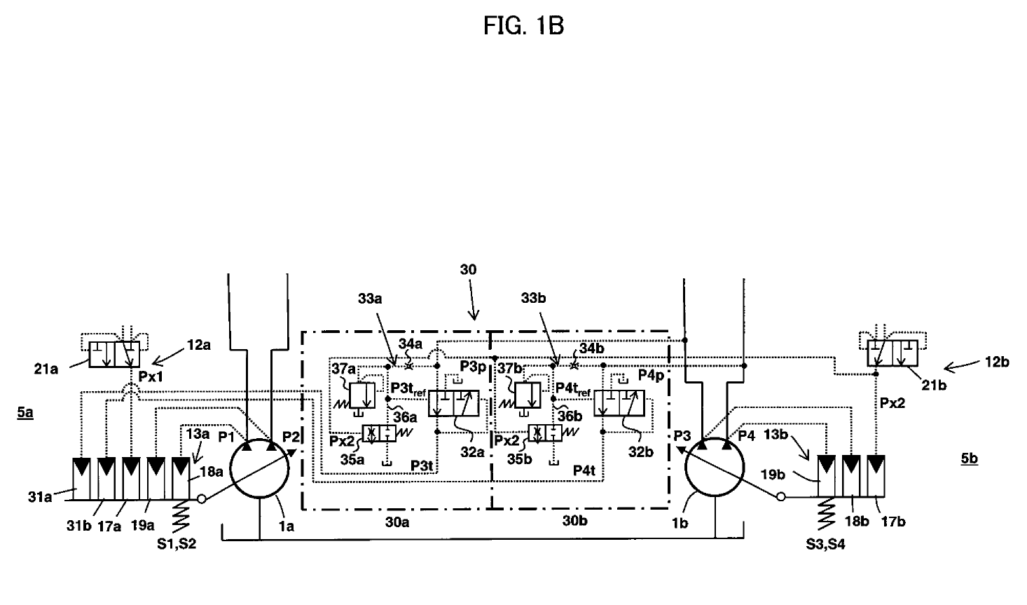

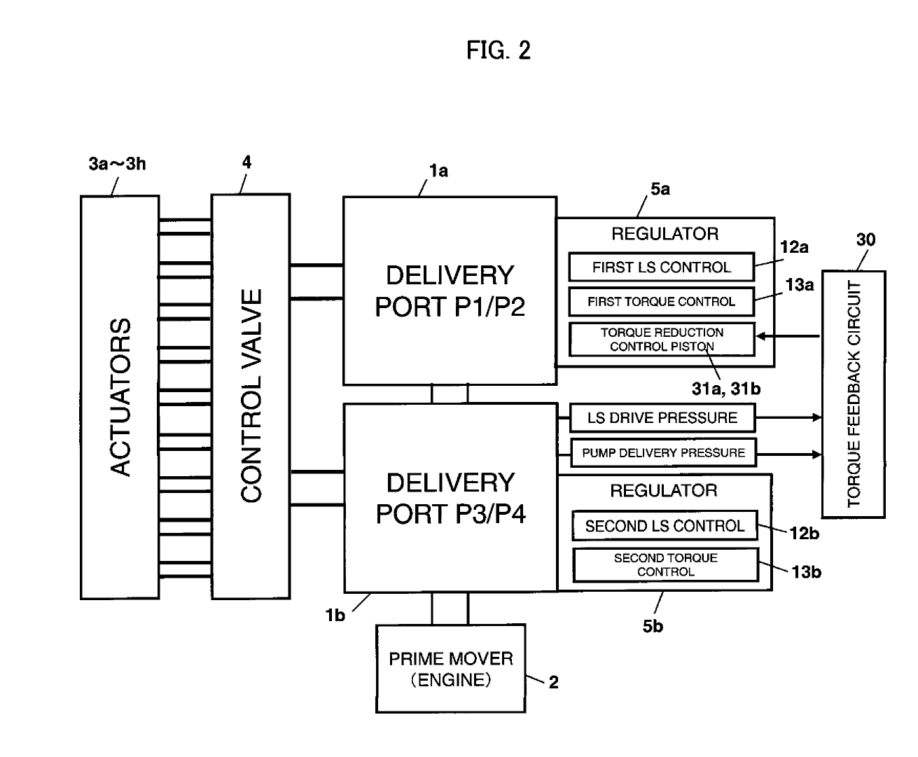

FIGS. 1A, 1B and 2 are diagrams showing a hydraulic drive system for a hydraulic excavator (construction machine) according to a first embodiment of the present invention. FIG. 1A is a hydraulic circuit diagram showing the whole of the hydraulic drive system, and FIG. 2 is a block diagram showing the whole of the hydraulic drive system. FIG. 1B is a hydraulic circuit diagram showing the details of a torque feedback circuit shown in FIGS. 1A and 2.

In FIGS. 1A and 2, the hydraulic drive system according to this embodiment includes: a variable displacement first hydraulic pump 1a having two delivery ports, namely, first and second delivery ports P1 and P2; a variable displacement second hydraulic pump 1b having two delivery ports, namely, third and fourth delivery ports P3 and P4; a prime mover 2 that is connected to the first and second hydraulic pumps 1a and 1b and drives the first and second hydraulic pumps 1a and 1b; a plurality of actuators 3a to 3h driven by hydraulic fluid delivered from the first and second delivery ports P1 and P2 of the first and second hydraulic pumps 1a and hydraulic fluid delivered from the third and fourth delivery ports P3 and P4 of the second hydraulic pump 1b; and a control valve 4 that is disposed between the first to fourth delivery ports P1 to P4 of the first and second hydraulic pumps 1a and 1b and the plurality of actuators 3a to 3h and controls flows of the hydraulic fluid supplied from the first to fourth delivery ports P1 to P4 of the first and second hydraulic pumps 1a and 1b to the plurality of actuators 3a to 3h.

The capacity of the first hydraulic pump 1a and the capacity of the second hydraulic pump 1b are the same. The capacity of the first hydraulic pump 1a and the capacity of the second hydraulic pump 1b may be different.

The first hydraulic pump 1a has a first pump control unit (regulator) 5a provided in common to the first and second delivery ports P1 and P2. Similarly, the second hydraulic pump 1b has a second pump control unit (regulator) 5b provided in common to the third and fourth delivery ports P3 and P4.

In addition, the first hydraulic pump 1a is a split flow type hydraulic pump provided with a single capacity control element (swash plate), and the first pump control unit 5a drives the single capacity control element to control the capacity (tilting angle of the swash plate) of the first hydraulic pump 1a, thereby controlling delivery flow rates of the first and second delivery ports P1 and P2. Similarly, the second hydraulic pump 1b is a split flow type hydraulic pump provided with a single capacity control element (swash plate), and the second pump control unit 5b drives the single capacity control element to control the capacity (tilting angle of the swash plate) of the second hydraulic pump 1b, thereby controlling delivery flow rates of the third and fourth delivery ports P3 and P4.

Each of the first and second hydraulic pumps 1a and 1b may be a combination of two variable displacement hydraulic pumps each having a single delivery port. In that case, the two capacity control elements (swash plates) of the two hydraulic pumps of the first hydraulic pump 1a may be driven by the first pump control unit 5a, and the two capacity control elements (swash plates) of the two hydraulic pumps of the second hydraulic pump 1b may be driven by the second pump control unit 5b.

The prime mover 2 is, for example, a diesel engine. As publicly known, a diesel engine has, for example, an electronic governor, which controls fuel injection amount, whereby revolution speed and torque are controlled. The engine resolution speed is set by operation means such as an engine control dial. The prime mover 2 may be an electric motor.

The control valve 4 includes: a plurality of closed center type flow control valves 6a to 6m; pressure compensating valves 7a to 7m that are connected to the upstream side of the flow control valves 6a to 6m and control differential pressures across meter-in restrictor parts of the flow control valves 6a to 6m; a first shuttle valve group 8a that is connected to load pressure ports of the flow control valves 6a to 6c and detects a maximum load pressure of the actuators 3a, 3b and 3e; a second shuttle valve group 8b that is connected to load pressure ports of the flow control valves 6d to 6f and detects a maximum load pressure of the actuators 3a, 3c and 3d; a third shuttle valve group 8c that is connected to load pressure ports of the flow control valves 6g to 6i and detects a maximum load pressure of the actuators 3e, 3f and 3h; a fourth shuttle valve group 8d that is connected to load pressure ports of the flow control valves 6j and 6m and detects a maximum load pressure of a spare actuator when the spare actuator is connected to the actuators 3d, 3g and 3h and the flow control valve 6m; first and second unloading valves 10a and 10b that are connected respectively to the delivery ports P1 and P2 of the first hydraulic pump 1a, and that are put into an open state when the delivery pressures of the delivery ports P1 and P2 become higher than pressures obtained by adding set pressures (unloading pressures) of springs 9a and 9b to the maximum load pressure detected by the first and second shuttle valve groups 8a and 8b, so that the hydraulic fluid from the delivery ports P1 and P2 is returned into a tank, thereby limiting a rise in the delivery pressures; third and fourth unloading valves 10c and 10d that are connected respectively to the delivery ports P3 and P4 of the second hydraulic pump 1b, and that are put into an open state when the delivery pressures of the delivery ports P3 and P4 become higher than pressures obtained by adding set pressures (unloading pressures) of springs 9c and 9d to the maximum load pressure detected by the third and fourth shuttle valve groups 8c and 8d, so that the hydraulic fluid from the delivery ports P3 and P4 is returned into a tank, thereby limiting a rise in the delivery pressures; a first communication control valve 15a disposed between respective delivery hydraulic lines of the first and second delivery ports P1 and P2 of the first hydraulic pump 1a and between respective output hydraulic lines of the first and second shuttle valve groups 8a and 8b; and a second communication control valve 15b disposed between respective delivery hydraulic lines of the third and fourth delivery ports P3 and P4 of the second hydraulic pump 1b and between respective output hydraulic lines of the third and fourth shuttle valve groups 8c and 8d. The set pressures of the springs 9a to 9d of the first to fourth unloading valves 10a to 10d are set to be equal to or slightly higher than a target differential pressure in a load sensing control described later.

Besides, though not shown in the drawings, the control valve 4 includes first and second main relief valves that are connected respectively to the delivery ports P1 and P2 of the first hydraulic pump 1a and function as safety valves, and third and fourth main relief valves that are connected respectively to the delivery ports P3 and P4 of the second hydraulic pump 1b and function as safety valves.

The pressure compensating valves 6a to 6f are configured such that differential pressures between the delivery pressures of the delivery ports P1 and P2 of the first hydraulic pump 1a and the maximum load pressure detected by the first and second shuttle valve groups 8a and 8b are set as target compensation pressures. The pressure compensating valves 7g to 7m are configured such that differential pressures between the delivery pressures of the delivery ports P3 and P4 of the second hydraulic pump 1b and the maximum load pressure detected by the third and fourth shuttle valve groups 8c and 8d are set as target compensation pressures. Specifically, the pressure compensating valves 7a to 7c perform such a control that the delivery pressure of the first delivery port P1 is introduced to an opening direction operation side, the maximum load pressure of the actuators 3a to 3e detected by the first and second shuttle valve groups 8a and 8b is introduced to a closing direction operation side, and differential pressures across the meter-in restrictor parts of the flow control valves 6a to 6c become equal to the differential pressure between the delivery pressure and the maximum load pressure. The pressure compensating valves 7d to 7f perform such a control that the delivery pressure of the second delivery port P2 is introduced to an opening direction operation side, the maximum load pressure of the actuators 3a to 3e detected by the first and second shuttle valve groups 8a and 8b is introduced to a closing direction operation side, and differential pressures across the meter-in restrictor arts of the flow control valves 6d to 6f become equal to the differential pressure between the delivery pressure and the maximum load pressure. The pressure compensating valves 7g to 7i perform such a control that the delivery pressure of the third delivery port P3 is introduced to an opening direction operation side, the maximum load pressure of the actuators 3d to 3h detected by the third and fourth shuttle valve groups 8c and 8d is introduced to a closing direction operation side, and differential pressures across the meter-in restrictor parts of the flow control valves 6g to 6i become equal to the differential pressure between the delivery pressure and the maximum load pressure. The pressure compensating valves 7j to 7m perform such a control that the delivery pressure of the fourth delivery port P4 is introduced to an opening direction operation side, the maximum load pressure of the actuators 3d to 3h detected by the third and fourth shuttle valve groups 8c and 8d is introduced to a closing direction operation side, and differential pressures across the meter-in restrictor parts of the flow control valves 6j to 6m become equal to the differential pressure between the delivery pressure and the maximum load pressure. This structure ensures that at the time of a combined operation of simultaneously driving the plurality of actuators respectively in the first hydraulic pump 1a and the second hydraulic pump 1b, a distribution of flow rates according to the opening area ratios of the flow control valves can be performed irrespectively of the magnitude of the load pressures of the actuators. In addition, even in a saturation state in which the delivery flow rates of the first to fourth delivery ports P1 to P4 are deficient, it is possible to reduce the differential pressures across the meter-in restrictor parts of the flow control valves according to the degree of saturation, and thereby to secure good properties for the combined operation.

The plurality of actuators 3a to 3d are, for example, an arm cylinder, a bucket cylinder, a swing cylinder, and a left travelling motor, respectively, of a hydraulic excavator. The plurality of actuators 3e to 3h are, for example, a right travelling motor, a swing cylinder, a blade cylinder, and a boom cylinder, respectively.

Here, the arm cylinder 3a is connected to the first and second delivery ports P1 and P2 through the flow control valves 6a and 6e and the pressure compensating valves 7a and 7e such that both the hydraulic fluids delivered from the first and second delivery ports P1 and P2 of the first hydraulic pump 1a are supplied in a joining manner. The boom cylinder 3h is connected to the third and fourth delivery ports P3 and P4 through the flow control valves 6h and 6l and the pressure compensating valves 7h and 7l such that both the hydraulic fluids delivered from the third and fourth delivery ports P3 and P4 of the second hydraulic pump 1b are supplied in a joining manner.

The travelling-left travelling motor 3d is connected to the second and fourth delivery ports P2 and P4 through the flow control valves 6f and 6j and the pressure compensating valves 7f and 7j such that the hydraulic fluid delivered from the second delivery port P2 as one delivery port of the first and second delivery ports P1 and P2 of the first hydraulic pump 1a and the hydraulic fluid delivered from the fourth delivery port P4 as one of the third and fourth delivery ports P3 and P4 of the second hydraulic pump 1b are supplied in a joining manner. The travelling-right travelling motor 3e is connected to the first and third delivery ports P1 and P3 through the flow control valves 6c and 6g and the pressure compensating valves 7c and 7g such that the hydraulic fluid delivered from the first delivery port P1 as the other delivery port of the first and second delivery ports P1 and P2 of the first hydraulic pump 1a and the hydraulic fluid delivered from the third delivery port P3 as the other delivery port of the third and fourth delivery ports P3 and P4 of the second hydraulic pump 1b are supplied in a joining manner.

Besides, the bucket cylinder 3b is connected to the first delivery port P1 of the first hydraulic pump 1a through the flow control valve 6b and the pressure compensating valve 7b so that the hydraulic fluid delivered from the first delivery port P1 is supplied to the bucket cylinder 3b. The swing motor 3c is connected to the second delivery port P2 of the first hydraulic pump 1a through the flow control valve 6d and the pressure compensating valve 7d so that the hydraulic fluid delivered from the second delivery port P2 is supplied to the swing motor 3c.

The swing cylinder 3f is connected to the third delivery port P3 of the second hydraulic pump 1b through the flow control valve 6i and the pressure compensating valve 7i so that the hydraulic fluid delivered from the third delivery port P3 is supplied to the swing cylinder 3f. The blade cylinder 3g is connected to the fourth delivery port P4 of the second hydraulic pump 1b through the flow control valve 6k and the pressure compensating valve 7k so that the hydraulic fluid delivered from the fourth delivery port P4 is supplied to the blade cylinder 3g.

The flow control valve 6m and the pressure compensating valve 7m are for use as spare (accessory); for example, in the case where the bucket 308 is replaced by a crusher, an opening/closing cylinder of the crusher is connected to the fourth delivery port P4 through the flow control valve 6m and the pressure compensating valve 7m.

The first communication control valve 15a is in an interruption position of the upper side in the drawing at the time other than the combined operation of simultaneously driving the travelling motors 3d and 3e and at least one of the other actuators (the boom cylinder 3c, the bucket cylinder 3b, and the swing motor 3c) concerning the first hydraulic pump 1a (hereinafter referred to as the time other than the travelling combined operation), and is changed over to a communication position of the lower side in the drawing at the time of the combined operation of simultaneously driving the travelling motors 3d and 3e and at least one of the other actuators (hereinafter referred to as the time of the travelling combined operation).

The second communication control valve 15b is in an interruption position of the upper side in the drawing at the time other than the combined operation of simultaneously driving the travelling motors 3d and 3e and at least one of the other actuators (the swing cylinder 3f, the blade cylinder 3g, and the boom cylinder 3h) concerning the second hydraulic pump 1b (hereinafter referred to as the time other than the travelling combined operation), and is changed over to a communication position of the lower side in the drawing at the time of the combined operation of simultaneously driving the travelling motors 3d and 3e and at least one of the other actuators (hereinafter referred to as the time of the travelling combined operation).

When the first communication control valve 15a is in the interruption position of the upper side in the drawing, it interrupts the communication between respective delivery hydraulic lines of the first and second delivery ports P1 and P2 of the first hydraulic pump 1a, and, when changed over to the communication position of the lower side in the drawing, the first communication control valve 15a causes the respective delivery hydraulic lines of the first and second delivery ports P1 and P2 of the first hydraulic pump 1a to communicate with each other.

Similarly, when the second communication control valve 15b in the interruption position of the upper side in the drawing, it interrupts the communication between respective delivery hydraulic lines of the third and fourth delivery ports P3 and P4 of the second hydraulic pump 1b, and, when changed over to the communication position of the lower side in the drawing, the second communication control valve 15b causes the respective delivery hydraulic lines of the third and fourth delivery ports P3 and P4 of the second hydraulic pump 1b to communicate with each other.

In addition, the first communication control valve 15a incorporates a shuttle valve therein. When in the interruption position of the upper side in the drawing, the first communication control valve 15a interrupts the communication between an output hydraulic line of the first shuttle valve group 8a and an output hydraulic line of the second shuttle valve group 8b, and causes the respective output hydraulic lines of the first and second shuttle valve groups 8a and 8b to communicate with the downstream side. When changed over to the communication position of the lower side in the drawing, the first communication control valve 15a causes the respective output hydraulic lines of the first and second shuttle valve groups 8a and 8b to communicate with each other through the shuttle valve, thereby to introduce a maximum load pressure on the high-pressure side to the downstream side.

Similarly, the second communication control valve 15b incorporates a shuttle valve therein. When in the interruption position of the upper side in the drawing, the second communication control valve 15b interrupts the communication between an output hydraulic line of the third shuttle valve group 8c and an output hydraulic line of the fourth shuttle valve group 8d, and causes the respective output hydraulic lines of the third and fourth shuttle valve groups 8c and 8d to communicate with the downstream side. When changed over to the communication position of the lower side in the drawing, the second communication control valve 15b causes the respective output hydraulic lines of the third and fourth shuttle valve groups 8c and 8d to communicate with each other through the shuttle valve, thereby to introduce a maximum load pressure on the high-pressure side to the downstream side.

When the first communication control valve 15a is in the interruption position of the upper side in the drawing, in the side of the first delivery port P1 of the first hydraulic pump 1a, the maximum load pressure of the actuators 3a, 3b and 3e detected by the first shuttle valve group 8a is introduced to the first unloading valve 10a and the pressure compensating valves 7a to 7c, so that based on the maximum load pressure, the first unloading valve 10a limits a rise in the delivery pressure of the first delivery port P1, and the pressure compensating valves 7a to 7c control the differential pressures across the meter-in restrictor parts of the flow control valves 6a to 6c. In the side of the second delivery port P2 of the second hydraulic pump 1a, the maximum load pressure of the actuators 3a, 3c and 3d detected by the second shuttle valve group 8b is introduced to the second unloading valve 10b and the pressure compensating valves 7d to 7f, so that based on the maximum load pressure, the second unloading valve 10b limits a rise in the delivery pressure of the second delivery port P2, and the pressure compensating valves 7d to 7f control the differential pressures across the meter-in restrictor parts of the flow control valves 6d to 6f.

When the first communication control valve 15a is changed over to the communication position of the lower side in the drawing, in the side of the first delivery port P1 of the first hydraulic pump 1a, the maximum load pressure of the actuators 3a to 3e detected by the first and second shuttle valve groups 8a and 8b is introduced to the first unloading valve 10a and the pressure compensating valves 7a to 7c, so that based on the maximum load pressure, the first unloading valve 10a limits a rise in the delivery pressure of the first delivery port P1, and the pressure compensating valves 7a to 7c control the differential pressures across the meter-in restrictor parts of the flow control valves 6a to 6c. Similarly, in the side of the second delivery port P2 of the second hydraulic pump 1a, the maximum load pressure of the actuators 3a to 3e detected by the first and second shuttle valve groups 8a and 8b is introduced to the second unloading valve 10b and the pressure compensating valves 7d to 7f, so that based on the maximum load pressure, the second unloading valve 10b limits a rise in the delivery pressure of the second delivery port P2, and the pressure compensating valves 7d to 7f control the differential pressures across the meter-in restrictor parts of the flow control valves 6d to 6f.

When the second communication control valve 15b is in the interruption position of the upper side in the drawing, in the side of the third delivery port P3 of the second hydraulic pump 1b, the maximum load pressure of the actuators 3e, 3f and 3h detected by the third shuttle valve group 8c is introduced to the third unloading valve 10c and the pressure compensating valves 7g to 7i, so that based on the maximum load pressure, the third unloading valve 10c limits a rise in the delivery pressure of the third delivery port P3, and the pressure compensating valves 7g to 7i control the differential pressures across the meter-in restrictor parts of the flow control valves 6g to 6i. In the side of the fourth delivery port P4 of the second hydraulic pump 1b, the maximum load pressure of the actuators 3d, 3g and 3h detected by the fourth shuttle valve group 8d is introduced to the fourth unloading vale 10d and the pressure compensating valves 7j to 7m, so that based on the maximum load pressure, the fourth unloading valve 10d limits a rise in the delivery pressure of the fourth delivery port P4, and the pressure compensating valves 7j to 7m control the differential pressures across the meter-in restrictor parts of the flow control valves 6j to 6m.

When the second communication control valve 15b is changed over to the communication position of the lower side in the drawing, in the side of the third delivery port P3 of the second hydraulic pump 1b, the maximum load pressure of the actuators 3d to 3h detected by the third and fourth shuttle valve groups 8c and 8d is introduced to the third unloading valve 10c and the pressure compensating valves 7g to 7i, so that based on the maximum load pressure, the third unloading valve 10c limits a rise in the delivery pressure of the third delivery port P3, and the pressure compensating valves 7g to 7i control the differential pressures across the meter-in restrictor parts of the flow control valves 6g to 6i. Similarly, in the side of the fourth delivery port P4 of the second hydraulic pump 1b, the maximum load pressure of the actuators 3d to 3h detected by the third and fourth shuttle valve groups 8c and 8d is introduced to the fourth unloading valve 10d and the pressure compensating valves 7j to 7m, so that based on the maximum load pressure, the fourth unloading valve 10d limits a rise in the delivery pressure of the fourth delivery port P4, and the pressure compensating valves 7j to 7m control the differential pressures across the meter-in restrictor parts of the flow control valves 6j to 6m.

The first pump control unit 5a includes: a first load sensing control section 12a for controlling the tilting angle of the swash plate (capacity) of the first hydraulic pump 1a in such a manner that the delivery pressures of the first and second delivery ports P1 and P2 of the hydraulic pump 1a become higher by a predetermined pressure than the maximum load pressure of the actuators 3a to 3e driven by the hydraulic fluids delivered from the first and second delivery ports P1 and P2 in the plurality of actuators 3a to 3h; and a first torque control section 13a for limiting and controlling the tilting angle of the swash plate (capacity) of the first hydraulic pump 1a in such a manner that the absorption torque of the first hydraulic pump 1a does not exceed a predetermined value.

The second pump control unit 5b includes: a second load sensing control section 12b for controlling the tilting angle of the swash plate (capacity) of the second hydraulic pump 1b in such a manner that the delivery pressures of the third and fourth delivery ports P3 and P4 of the second hydraulic pump 1b become higher by a predetermined angle than the maximum load pressure of the actuators 3d to 3h driven by the hydraulic fluids delivered from the third and fourth delivery ports P3 and P4 in the plurality of actuators 3a to 3h; and a second torque control section 13b for limiting and controlling the tilting angle of the swash plate (capacity) of the second hydraulic pump 1b in such a manner that the absorption torque of the second hydraulic pump 1b does not exceed a predetermined value.

The first load sensing control section 12a includes: load sensing control valves 16a and 16b for generating load sensing drive pressures (hereinafter referred to as LS drive pressures); a low pressure selection valve 21a for selecting and outputting the lower pressure side of the LS drive pressures generated by the load sensing control valves 16a and 16b; and a load sensing control piston (load sensing control actuator) 17a to which the LS drive pressure selected and outputted by the low pressure selection valve 21a is introduced and which varies the tilting angle of the swash plate of the first hydraulic pump 1a according to the LS drive pressure.

The second load sensing control section 12b includes: load sensing control valves 16c and 16d for generating load sensing drive pressures (hereinafter referred to as LS drive pressures); a low pressure selection valve 21b for selecting and outputting a lower pressure side of the LS drive pressures generated by the load sensing control valves 16c and 16d; and a load sensing control piston (load sensing control actuator) 17b to which the LS drive pressure selected and outputted by the low pressure selection valve 21b is introduced and which varies the tilting angle of the swash plate of the second hydraulic pump 1b according to the LS drive pressure.

In the first load sensing control section 12a, a control valve 16a includes: a spring 16a1 for setting a target differential pressure for a load sensing control; a pressure receiving part 16a2 which is located opposite to the spring 16a1 and to which the delivery pressure of the first delivery port P1 is introduced; and a pressure receiving part 16a3 located on the same side as the spring 16a1. When the first communication control valve 15a is in the interruption position of the upper side in the drawing, the maximum load pressure of the actuators 3a, 3b and 3e detected by the first shuttle valve group 8a is introduced to the pressure receiving part 16a3 of the control valve 16a. When the first communication control valve 15a is changed over to the communication position of the lower side in the drawing, the maximum load pressure of the actuators 3a to 3e detected by the first and second shuttle valve groups 8a and 8b is introduced to the pressure receiving part 16a3 of the control valve 16a. The control valve 16a is displaced according to the balance among the delivery pressure of the first delivery port P1 introduced to the pressure receiving part 16a2, the maximum load pressure of the actuators 3a, 3b and 3e or the actuators 3a to 3e introduced to the pressure receiving part 16a3, and a biasing force of the spring 16a1, thereby to vary the LS drive pressure.

In other words, when the delivery pressure of the first delivery port P1 introduced to the pressure receiving part 16a2 becomes higher than a pressure obtained by adding the target differential pressure (predetermined pressure) set by the spring 16a1 to the maximum load pressure introduced to the pressure receiving part 16a2, the control valve 16a is moved leftward in the drawing to cause its secondary port to communicate with a hydraulic fluid source (the first delivery port P1), thereby raising the LS drive pressure. When the delivery pressure on the high pressure side of the first delivery port P1 introduced to the pressure receiving part 16a2 becomes lower than a pressure obtained by adding the target differential pressure (predetermined pressure) set by the spring 16a1 to the maximum load pressure introduced to the pressure receiving part 16a2, the control valve 16a is moved rightward in the drawing to cause the secondary port to communicate with the tank, thereby lowering the LS drive pressure. The hydraulic fluid source that the secondary port communicates with when the control valve 16a is moved leftward in the drawing may be a pilot hydraulic fluid source that is formed in a delivery hydraulic line of a pilot pump and generates a fixed pilot pressure.

The control valve 16b includes: a spring 16b1 for setting a target differential pressure for a load sensing control; a pressure receiving part 16b2 which is located opposite to the spring 16b1 and to which the delivery pressure of the second delivery port P2 is introduced; and a pressure receiving part 16b3 located on the same side as the spring 16b1. When the first communication control valve 15a is situated in the interruption position of the upper side in the drawing, the maximum load pressure of the actuators 3a, 3c and 3d detected by the second shuttle valve group 8b is introduced to the pressure receiving part 16b3 of the control valve 16b. When the first communication control valve 15a is changed over to the communication position of the lower side in the drawing, the maximum load pressure of the actuators 3a to 3e detected by the first and second shuttle valve groups 8a and 8b is introduced to the pressure receiving part 16a3 of the control valve 16b. The control valve 16b is displaced according to the balance among the delivery pressure of the second delivery port P2 introduced to the pressure receiving part 16b2, the maximum load pressure of the actuators 3a, 3c and 3d or the actuators 3a to 3e introduced to the pressure receiving part 16b3, and the biasing force of the spring 16b1, thereby varying the LS drive pressure, like the control valve 16a.

The low pressure selection valve 21a selects the lower pressure side of the LS drive pressures generated by the load sensing control valves 16a and 16b, and outputs the selected LS drive pressure to the load sensing control piston 17a. Based on the LS drive pressure, the load sensing control piston 17a varies the tilting angle of the swash plate of the first hydraulic pump 1a, and thereby varies the delivery flow rates of the first and second delivery ports P1 and P2.

In the second load sensing control section 12b, the control valve 16c includes: a spring 16c1 for setting a target differential pressure for a load sensing control; a pressure receiving part 16c2 which is located opposite to the spring 16c1 and to which the delivery pressure of the third delivery port P3 is introduced; and a pressure receiving part 16c3 located on the same side as the spring 16c1. When the second communication control valve 15b is located in the interruption position of the upper side in the drawing, the maximum load pressure of the actuators 3e, 3f and 3h detected by the third shuttle valve group 8c is introduced to the pressure receiving part 16c3 of the control valve 16c. When the second communication control valve 15b is changed over to the communication position of the lower side in the drawing, the maximum load pressure of the actuators 3d to 3h detected by the third and fourth shuttle valve groups 8c and 8d is introduced to the pressure receiving part 16c3 of the control valve 16c. The control valve 16c is displaced according to the balance among the delivery pressure of the third delivery port P3 introduced to the pressure receiving part 16c2, the maximum load pressure of the actuators 3e, 3f and 3h or the actuators 3d to 3h introduced to the pressure receiving part 16c3, and a biasing force of the spring 16c1, thereby varying the LS drive pressure, like the control valve 16a.

The control valve 16d includes: a spring 16d1 for setting a target differential pressure for a load sensing control; a pressure receiving part 16d2 which is located opposite to the spring 16d1 and to which the delivery pressure of the fourth delivery port P4 is introduced; and a pressure receiving part 16d located on the same side as the spring 16d1. When the second communication control valve 15b is located in the interruption position of the upper side in the drawing, the maximum load pressure of the actuators 3d, 3g and 3h detected by the fourth shuttle valve group 8d is introduced to the pressure receiving part 16d3 of the control valve 16d. When the second communication control valve 15b is changed over to the communication position of the lower side in the drawing, the maximum load pressure of the actuators 3d to 3h detected by the third and fourth shuttle valve groups 8c and 8d is introduced to the pressure receiving part 16d3 of the control valve 16d. The control valve 16d is displaced according to the balance among the delivery pressure of the fourth delivery port P4 introduced to the pressure receiving part 16d2, the maximum load pressure of the actuators 3d, 3g and 3h or the actuators 3d to 3h introduced to the pressure receiving part 16d3, and a biasing force of the spring 16d1, thereby varying the LS drive pressure, like the control valve 16a.

The low pressure selection valve 21b selects the lower pressure side of the LS drive pressures generated by the load sensing control valves 16c and 16d, and outputs the selected LS drive pressure to the load sensing control piston 17b. Based on the LS drive pressure, the load sensing control piston 17b varies the tilting angle of the swash plate of the second hydraulic pump 1b, and thereby varies the delivery flow rates of the third and fourth delivery ports P3 and P4.

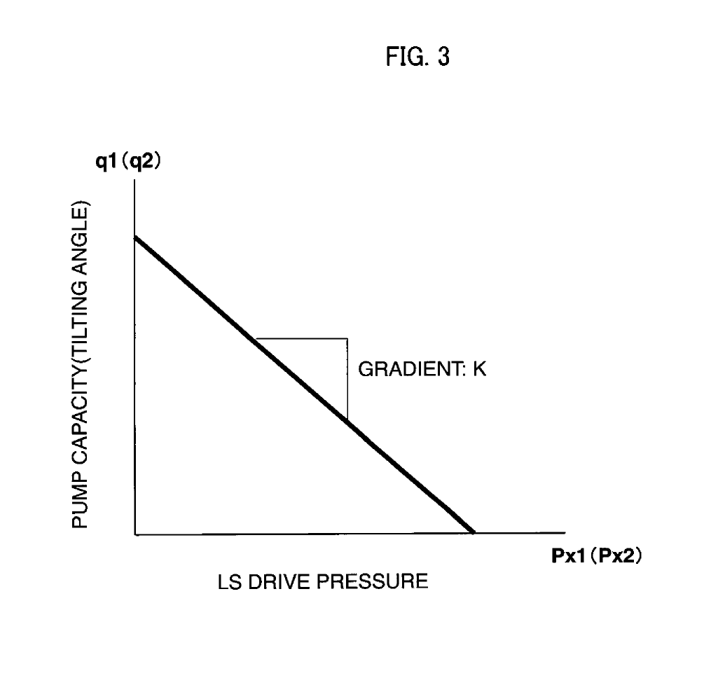

FIG. 3 is a diagram showing the relation between LS drive pressures and tilting angles of swash plates of the first and second hydraulic pumps 1a and 1b when the load sensing control pistons 17a and 17b operate. In the diagram, the LS drive pressures acting on the load sensing control pistons 17a and 17b are denoted by Px1 and px2, and the tilting angles of the swash plates of the first and second hydraulic pumps 1a and 1b are denoted by q1 and q2.

As shown in FIG. 3, when the LS drive pressure Px1 rises, the load sensing control piston 17a reduces the tilting angle q1 of the swash plate of the first hydraulic pump 1a, thereby decreasing the delivery flow rates of the first and second delivery ports P1 and P2. When the LS drive pressure Px1 is lowered, the load sensing control piston 17a enlarges the tilting angle q1 of the swash plate of the first hydraulic pump 1a, thereby increasing the delivery flow rates of the first and second delivery ports P1 and P2. With such arrangement, the first load sensing control section 12a controls the tilting angle of the swash plate (capacity) of the first hydraulic pump 1a in such a manner that the delivery pressure on the high pressure side of the first and second delivery ports P1 and P2 of the first hydraulic pump 1a becomes higher by a predetermined pressure than the maximum load pressure of the actuators 3a to 3e driven by the hydraulic fluids delivered from the first and second delivery ports P1 and P2. In the diagram, K is the rate of change of the tilting angle q1 of the swash plate of the first hydraulic pump 1a in relation to the LS drive pressure Px1, and is a value determined by the relation between constants of springs S3 and S4 described later and the tilting angle q2 (capacity) of the second hydraulic pump 1b.

Like the load sensing control piston 17a, the load sensing control piston 17b varies the tilting angle q2 of the swash plate of the second hydraulic pump 1b in accordance with variation in the LS drive pressure Px2, thereby to control the tilting angle of the swash plate (capacity) of the second hydraulic pump 1b in such a manner that the delivery pressure on the high pressure side of the third and fourth delivery ports P3 and P4 of the second hydraulic pump 1b becomes higher by a predetermined pressure than the maximum load pressure of the actuators 3d to 3h driven by the hydraulic fluids delivered from the third and fourth delivery ports P3 and P4.

In the first and second load sensing control sections 12 and 12b, the target differential pressures for the load sensing control that are set by the springs 16a1 and 16b1 and the springs 16c1 and 16d1 are each, for example, about 2 MPa.

Besides, in the first pump control unit 5a, the first torque control section 13a includes: a first torque control piston (first torque control actuator) 18a to which the delivery pressure of the first delivery port P1 is introduced; a second torque control piston (first torque control actuator) 19a to which the delivery pressure of the second delivery port P2 is introduced; and springs S1 and S2 (in FIG. 1, only one spring is illustrated for simplification) as biasing means for setting a maximum torque T1max (first maximum torque).

The second torque control section 13b includes: a third torque control piston (second torque control actuator) 18b to which the delivery pressure of the third delivery port P3 is introduced; a fourth torque control piston (second torque control actuator) 19b to which the delivery pressure of the fourth delivery port P4 is introduced; and springs S3 and S4 (in FIG. 1, only one spring is illustrated for simplification) as biasing means for setting a maximum torque T2max (second maximum torque).

In addition, the first torque control section 13a includes: a torque feedback circuit 30 to which the delivery pressures of the third and fourth delivery ports P3 and P4 of the second hydraulic pump 1b and the LS drive pressure acting on the load sensing control piston 17b of the second load sensing control section 12b are introduced, which modifies the delivery pressures of the third and fourth delivery ports P3 and P4 of the second hydraulic pump 1b based on the delivery pressures of the third and fourth delivery ports P3 and P4 and the LS drive pressure to provide a characteristic simulating the absorption torque of the second hydraulic pump 1b both in the cases of when the second hydraulic pump 1b is limited by control of the second torque control section 13b and operates at the maximum torque T2max (second maximum torque) and when the second hydraulic pump 1b is not limited by the control of the second torque control section 13b and the second load sensing control section 12b controls the capacity of the second hydraulic pump 1b (when lower than a starting pressure Pb of an absorption torque constant control of the second hydraulic pump 1b described later), and which outputs the modified pressures; a first torque reduction control piston (third torque control actuator) 31a to which an output pressure of the torque feedback circuit 30 obtained by modification of the delivery pressure of the third delivery port P3 of the second hydraulic pump 1b is introduced, and which, as the output pressure rises, decreases the tilting angle of swash plate (capacity) of the first hydraulic pump 1a and decreases the maximum torque T1max set by the springs S1 and S2; and a second torque reduction control piston (third torque control actuator) 31b to which an output pressure of the torque feedback circuit 30 obtained by modification of the delivery pressure of the fourth delivery port P4 of the second hydraulic pump 1b is introduced, and which, as the output pressure rises, decreases the tilting angle of swash plate (capacity) of the first hydraulic pump 1a and decreases the maximum torque T1max set by the springs S1 and S2.

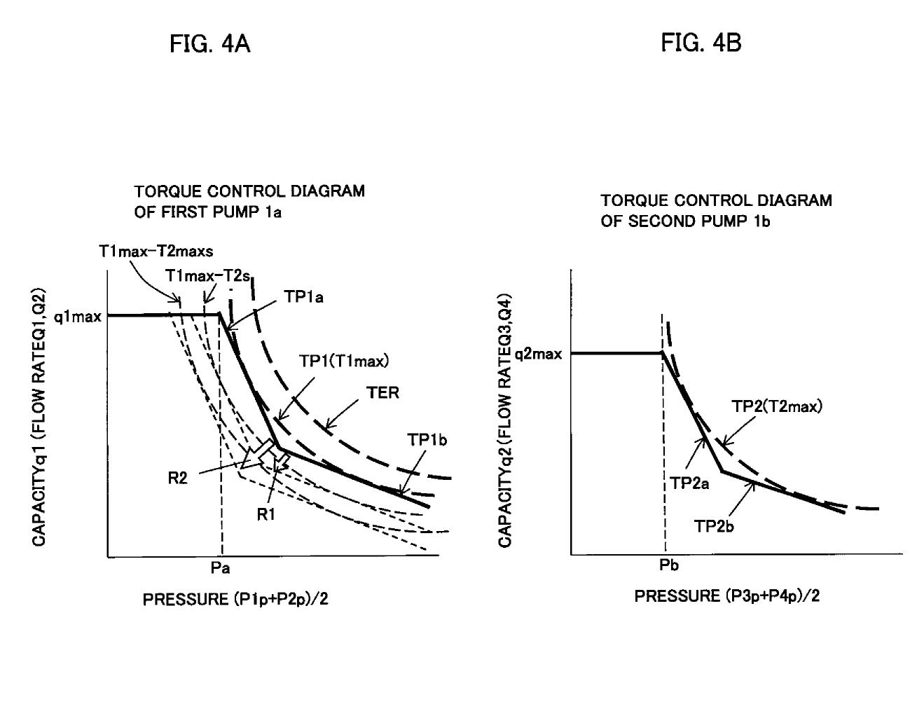

FIG. 4A is a torque control diagram for the first torque control section 13a, and FIG. 4B is a torque control diagram for the second torque control section 13b. In these torque control diagrams, the axis of ordinates represents the tilting angle (capacity) q1, q2, and these diagrams are turned to be horsepower control diagrams when the axis of ordinates is replaced by delivery flow rate Q1, Q2 or delivery flow rate Q3, Q4. Besides, the axis of abscissas represents pump delivery pressure; specifically, the axis of abscissas represents average delivery pressure (P1p+P2p/2) of the first and second delivery ports P1 and P2 in FIG. 4A, and represents average delivery pressure (P3p+P4p/2) of the third and fourth delivery ports P3 and P4 in FIG. 4B.

In FIG. 4A, when the hydraulic oil delivered by the second hydraulic pump 1b is not supplied to the actuators 3d to 3h, the torque feedback circuit 30 and the first and second torque reduction control pistons 31a and 31b do not function, and the maximum torque T1max is set in the first torque control section 13a by the springs S1 and S2. TP1a and TP1b are characteristic curves of the springs S1 and S2 for setting the maximum torque T1max.

In this condition, when the hydraulic fluid delivered by the first hydraulic pump 1a is supplied to one of the actuators 3a to 3e concerning the first hydraulic pump 1a and the average delivery pressure of the first and second delivery ports P1 and P2 rises, the first torque control section 13a does not operate during when the average delivery pressure is not more than a pressure (torque control start pressure) Pa at a starting end of the characteristic curve TP1a. In this case, the tilting angle of swash plate (capacity) q1 of the first hydraulic pump 1a is not limited by the control of the first torque control section 13a, and can be increased to the maximum tilting angle q1max possessed by the first hydraulic pump 1a according to an operation amount of a control lever device (demanded flow rate), under the control of the first load sensing control section 12a.

When the average delivery pressure of the first and second delivery ports P1 and P2 exceeds Pa in a condition where the swash plate of the first hydraulic pump 1a is at the maximum tilting angle q1max, the first torque control section 13a operates to perform an absorption torque constant control (or horsepower constant control) so as to decrease the maximum tilting angle (maximum capacity) of the first hydraulic pump 1a along the characteristic curves TP1a and TP1b as the average delivery pressure rises. In this case, the first load sensing control section 12a cannot increase the tilting angle of the first hydraulic pump 1a in excess of a tilting angle determined by the characteristic curves TP1a and TP1b.

As shown in the diagram, the characteristic curves TP1a and TP1b are set to be approximate to an absorption torque constant curve (hyperbola) TP1 by the two springs S1 and S2. With such setting, the first torque control section 13a performs the absorption torque constant control (or horsepower constant control) such that the absorption torque of the first hydraulic pump 1a does not exceed the maximum torque T1max when the average delivery pressure of the first hydraulic pump 1a rises. The maximum torque T1max is set to be slightly lower than a rated output torque TER of an engine 2.

In FIG. 4B, a maximum torque T2max is set in the second torque control section 13b by the springs S3 and S4, irrespectively of the operating conditions of the first hydraulic pump 1a. TP2a and TP2b are characteristic curves of the springs S3 and S4 for setting the maximum torque T1max.

When the hydraulic fluid delivered by the second hydraulic pump 1b is supplied to one of the actuators 3d to 3h concerning the second hydraulic pump 1b and the average delivery pressure of the third and fourth delivery ports P3 and P4 rises, the second torque control section 13b does not operate while the average delivery pressure is not more than a pressure (torque control start pressure) Pb at a starting end of the characteristic curve TP2a. In this case, the tilting angle of swash plate (capacity) q2 of the second hydraulic pump 1b is not limited by control of the second torque control section 13b, and the tilting angle can be increased to a maximum tilting angle q2max possessed by the second hydraulic pump 1b according to an operation amount of the control lever device (demanded flow rate), under control of the second load sensing control section 12b.

When the average delivery pressure of the third and fourth delivery ports P3 and P4 exceeds Pb in a condition where the swash plate of the second hydraulic pump 1b is at the maximum tilting angle q2max, the second torque control section 13b operates to perform an absorption torque constant control so as to decrease the maximum tilting angle (maximum capacity) of the second hydraulic pump 1b along the characteristic curves TP2a and TP2b as the average delivery pressure rises. In this case, the second load sensing control section 12b cannot increase the tilting angle of the second hydraulic pump 1b in excess of a tilting angle determined by the characteristic curves TP2a and TP2b.

As shown in the diagram, the characteristic curves TP2a and TP2b are set to be approximate to an absorption torque constant curve (hyperbola) TP2 by the two springs S3 and S4. With such setting, the second torque control section 13b performs an absorption torque constant control (or horsepower constant control) such that the absorption torque of the second hydraulic pump 1b does not exceed the maximum torque T2max when the average delivery pressure of the second hydraulic pump 1b rises. The maximum torque T2max is lower than the maximum torque T1max set in the first torque control section 13a, and is set to be about ½ times the rated output torque TER of the engine 2.

In addition, when the hydraulic fluid delivered by the second hydraulic pump 1b is supplied to one of the actuators 3d to 3h concerning the second hydraulic pump 1b and the one of the actuators 3d to 3h is driven by the hydraulic fluid delivered by the second hydraulic pump 1b, the torque feedback circuit 30 modifies the delivery pressures of the third and fourth delivery ports P3 and P4 of the second hydraulic pump 1b so as to attain a characteristic simulating the absorption torque of the second hydraulic pump 1b, and outputs the modified delivery pressures. In addition, the first and second torque reduction control pistons 31a and 31b decrease the maximum torque T1max set in the first torque control section 13a as the output pressure of the torque feedback circuit 30 rises.

In FIG. 4A, the two arrows R1 and R2 represent the effects of the first and second torque reduction control pistons 31a and 31b to decrease the maximum torque T1max. When the delivery pressures of the third and fourth delivery ports P3 and P4 of the second hydraulic pump 1b rise and when the absorption torque of the second hydraulic pump 1b in that instance is T2 which is lower than the maximum torque T2max and the absorption torque simulated by the torque feedback circuit 30 is T2s (≈T2max), the torque feedback pistons 32a and 32b decrease the maximum torque T1max to T1max−T2s, as indicated by the arrow R1 in FIG. 4A. In addition, when the absorption torque of the second hydraulic pump 1b is the maximum torque T2max and the absorption torque simulated by the torque feedback circuit 30 is T2maxs (≈T2max), the torque feedback pistons 32a and 32b decrease the maximum torque T1max to T1max−T2maxs, as indicated by the arrow R2 in FIG. 4A.

Here, the maximum torque T1max set in the first torque control section 13a is lower than the rated output torque TER of the engine 2, as aforementioned. In addition, when the hydraulic fluid delivered by the second hydraulic pump 1b is not supplied to the actuators 3d to 3h and the hydraulic fluid delivered by the first hydraulic pump 1a is supplied to one of the actuators 3a to 3e to drive the one of the actuators 3a to 3e, the first torque control section 13a performs an absorption torque constant control (or horsepower constant control) such that the absorption torque of the first hydraulic pump 1a does not exceed the maximum torque T1max, whereby the absorption torque of the first hydraulic pump 1a is controlled not to exceed the rated output torque TER of the engine 2. With such arrangement, stoppage of the engine 2 (engine stall) can be prevented, while making the most of the rated output torque TER of the engine 2.

In addition, when the hydraulic fluid delivered by the second hydraulic pump 1b is supplied to one of the actuators 3d to 3h and the one of the actuators 3d to 3h is driven by the hydraulic fluid delivered by the second hydraulic pump 1b, the torque feedback pistons 32a and 32b decrease the maximum torque T1max to T1max−T2s or T1max−T2maxs, as indicated by the arrow X in FIG. 4A, as aforementioned. With such arrangement, also in a combined operation of simultaneously driving one of the actuators 3a to 3e concerning the first hydraulic pump 1a and one of the actuators 3d to 3h concerning the second hydraulic pump 1b, a total torque control is conducted such that the total absorption torque of the first hydraulic pump 1a and the second hydraulic pump 1b does not exceed the rated output torque TER of the engine 2. In this case, also, stoppage of the engine 2 (engine stall) can be prevented, while making the most of the rated output torque TER of the engine 2.

FIG. 1B is a diagram showing the details of the torque feedback circuit 30.

The torque feedback circuit 30 includes: a first torque feedback circuit section 30a that modifies the delivery pressure of the third delivery port P3 of the second hydraulic pump 1b so as to attain a characteristic simulating the absorption torque of the second hydraulic pump 1b, and outputs the modified delivery pressure; and a second torque feedback circuit section 30b that modifies the delivery pressure of the fourth delivery port P4 of the second hydraulic pump 1b so as to attain a characteristic simulating the absorption torque of the second hydraulic pump 1b, and outputs the modified delivery pressure.

The first torque feedback circuit section 30a includes: a first torque pressure reduction valve 32a to which the delivery pressure of the third delivery port P3 is introduced; and a first pressure dividing circuit 33a that generates a target control pressure for setting a set pressure of the first torque pressure reduction valve 32a. When the delivery pressure of the third delivery port P3 is lower than the set pressure, the first torque pressure reduction valve 32a outputs the delivery pressure of the third delivery port P3 as a secondary pressure without reduction, whereas when the delivery pressure of the third delivery port P3 is higher than the set pressure, the first torque pressure reduction valve 32a reduces the delivery pressure of the third delivery port P3 to the set pressure (target control pressure) and outputs the thus reduced pressure. The output pressure (secondary pressure) is introduced to the first torque reduction control piston 31a as a torque control pressure.

The first pressure dividing circuit 33a includes: a first pressure dividing restrictor part 34a to which the delivery pressure of the third delivery port P3 is introduced; a first pressure dividing valve 35a located on a downstream side of the first pressure dividing restrictor part 34a; and a first relief valve (pressure limiting valve) 37a that is connected to a first hydraulic line 36a between the first pressure dividing restrictor part 34a and the first pressure dividing valve 35a and causes the pressure in the first hydraulic line 36a not to increase beyond a set pressure (relief pressure). The first pressure dividing restrictor part 34a is a fixed restrictor, and has a fixed opening area. The first pressure dividing valve 35a is a variable restrictor valve to which an LS drive pressure Px2 acting on the load sensing control piston 17b of the second load sensing control section 12b is introduced and which varies the opening area according to the LS drive pressure Px2. When the LS drive pressure Px2 is a tank pressure, the opening area of the first pressure dividing valve 35a is zero (fully closed). As the LS drive pressure Px2 rises, the opening area of the first pressure dividing valve 35a increases. When the LS drive pressure Px2 rises to be equal to or higher than a predetermined pressure, the opening area of the first pressure dividing valve 35a becomes maximum (fully opened). The target control pressure generated in the first hydraulic line 36a between the first pressure dividing restrictor 34a and the first pressure dividing valve 35a according to the variation in the opening area of the first pressure dividing valve 35a varies continuously from the set pressure of the first relief valve 37a to the tank pressure (zero). According to the variation in the target control pressure, a torque control pressure generated by the first torque pressure reduction valve 32a is also varied continuously. The set pressure of the first relief valve 37a is set to be equal to a torque control start pressure Pb (FIG. 4B) of the second torque control section 13b, in conformity with Pb.

The second torque feedback circuit section 30b also is configured similarly to the first torque feedback circuit section 30a. Specifically, the second torque feedback circuit section 30b includes: a second torque pressure reduction valve 32b to which the delivery pressure of the fourth delivery port P4 is introduced as a primary pressure; and a second pressure dividing circuit 33b that generates a target control pressure for providing a set pressure of the second torque pressure reduction valve 32b. When the delivery pressure of the fourth delivery port P4 is lower than the set pressure, the second torque pressure reduction valve 32b outputs the delivery pressure of the fourth delivery port P4 as a secondary pressure without reduction. When the delivery pressure of the fourth delivery port P4 is higher than the set pressure, the second torque pressure reduction valve 32b reduces the delivery pressure of the fourth delivery port P4 to the set pressure (target control pressure), and outputs the reduced pressure. The output pressure (secondary pressure) is introduced to the second torque reduction control piston 31b as a torque control pressure.

The second pressure dividing circuit 33b includes: a second pressure dividing restrictor part 34b to which the delivery pressure of the fourth delivery port P4 is introduced; a second pressure dividing valve 35b located on a downstream side of the second pressure dividing restrictor part 34b; and a second relief valve (pressure limiting valve) 37b that is connected to a second hydraulic line 36b between the second pressure dividing restrictor part 34b and the second pressure dividing valve 35b and causes the pressure in the second hydraulic line 36b not to increase beyond a set pressure (relief pressure). The second pressure dividing restrictor part 34b is a fixed restrictor, and has a fixed opening area. The second pressure dividing valve 35b is a variable restrictor valve to which the LS drive pressure Px2 acting on the load sensing control piston 17b of the second load sensing control section 12b is introduced, and which varies the opening area according to the LS drive pressure Px2. When the LS drive pressure Px2 is the tank pressure, the opening area of the first pressure dividing valve 35a is zero (fully closed). As the LS drive pressure Px2 rises, the opening area of the first pressure dividing valve 35a increases. When the LS drive pressure Px2 rises to be equal to or higher than a predetermined pressure, the opening area of the first pressure dividing valve 35a becomes maximum (fully opened). A target control pressure generated in the second hydraulic line 36b between the second pressure dividing restrictor 34b and the second pressure dividing valve 35b according to the variation in the opening area of the second pressure dividing valve 35b varies continuously from the set pressure of the second relief valve 37b to the tank pressure (zero). According to the variation in the target control pressure, a torque control pressure generated by the second torque pressure reduction valve 32b is also varied continuously. The set pressure of the second relief valve 37b is set to be equal to a torque control start pressure Pb (FIG. 4B) of the second torque control section 13b, in conformity with Pb.

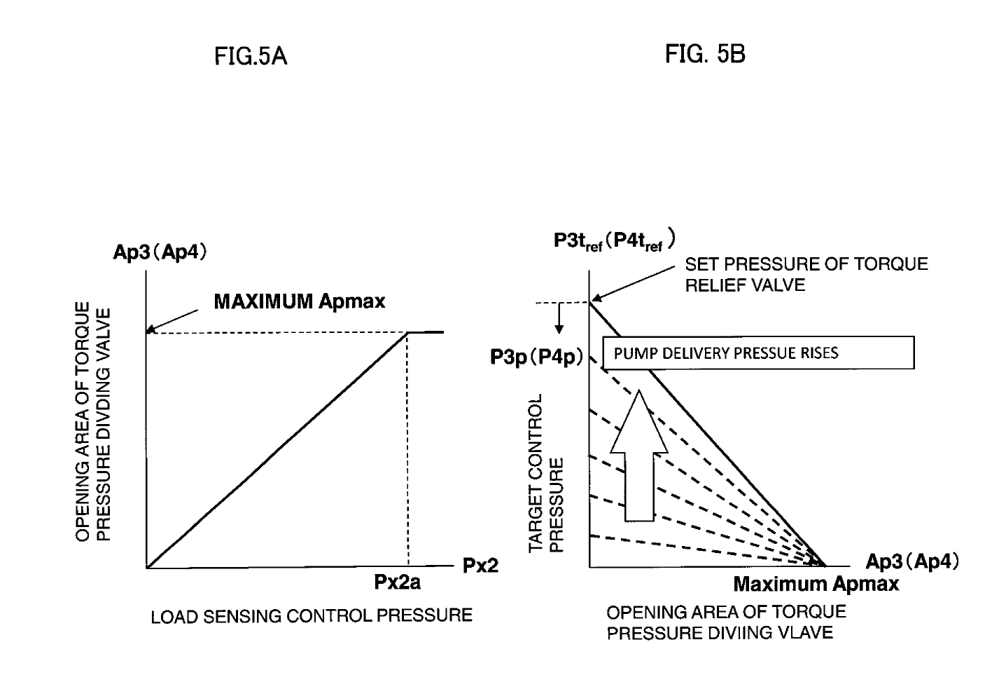

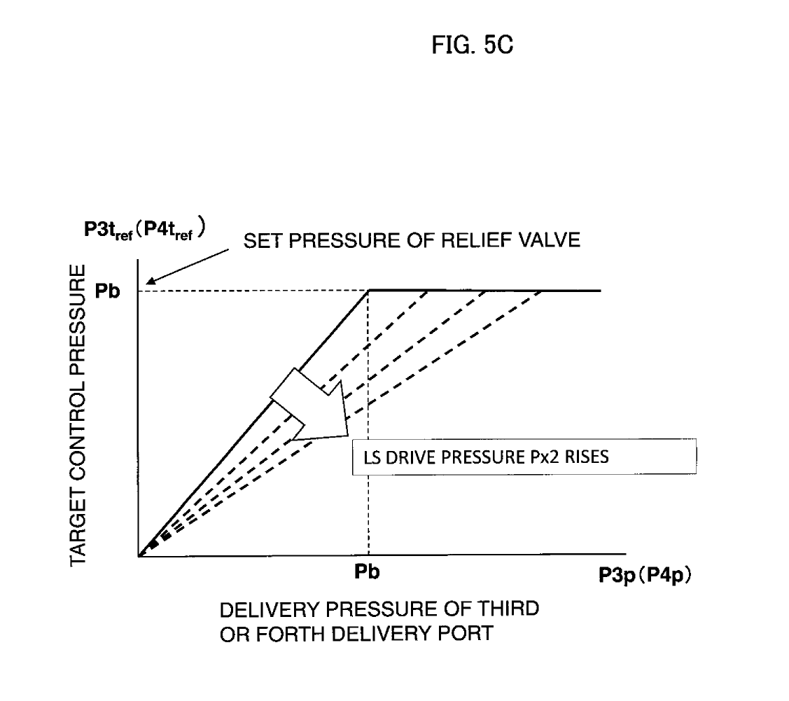

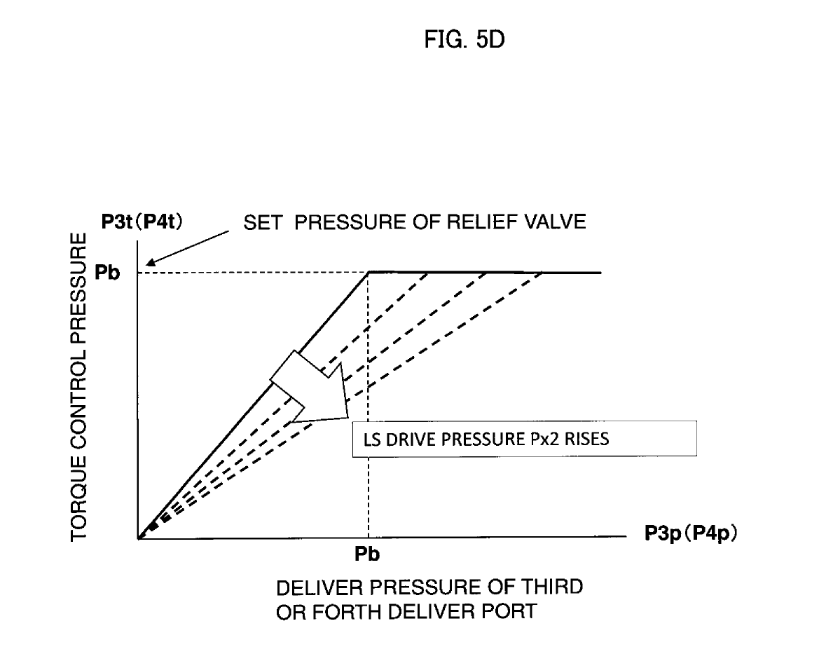

FIG. 5A is a diagram showing the relation between the LS drive pressure Px2 and the opening area of the first and second pressure dividing valves 35a and 35b; FIG. 5B is a diagram showing the relation between the opening area of the first and second pressure dividing valves 35a and 35b and a target control pressure; FIG. 5C is a diagram showing the relation between the delivery pressure of the third and fourth delivery ports and the target control pressure when the LS drive pressure Px2 varies; and FIG. 5D is a diagram showing the relation between the delivery pressure of the third and fourth delivery ports and a torque control pressure when the LS drive pressure Px2 varies. In the diagrams, AP3 and AP4 are opening areas of the first and second pressure dividing valves 35a and 35b; P3tref and P4tref are the target control pressures generated in the first and second hydraulic lines 36a and 36b; P3p and P4p are delivery pressures of the third and fourth delivery ports; and P3t and P4t are the torque control pressures generated by the first and second torque pressure reduction valves 32a and 32b.

As shown in FIG. 5A, when the LS drive pressure Px2 acting on the load sensing control piston 17b of the second load sensing control section 12b is the tank pressure, the opening areas AP3 and AP4 of the first and second pressure dividing valves 35a and 35b are zero (fully closed). As the LS drive pressure Px2 rises, the opening areas AP3 and AP4 of the first and second pressure dividing valves 35a and 35b increase. When the LS drive pressure Px2 rises to be equal to or higher than a predetermined pressure Px2a, the opening areas of the first and second pressure dividing valves 35a and 35b become maximum (fully opened).

As shown in FIG. 5B, when the opening areas AP3 and AP4 of the first and second pressure dividing valves 35a and 35b are zero (fully closed), the pressures in the first and second hydraulic lines 36a and 36b are equal to the delivery pressures P3p and P4p of the third and fourth delivery ports. It is to be noted, however, that the pressures in the first and second hydraulic lines 36a and 36b cannot become equal to or higher than the set pressures of the first and second relief valves 37a and 37b. As the opening areas AP3 and AP4 of the first and second pressure dividing valves 35a and 35b increase from the zero (fully closed), the target control pressures P3tref and P4tref are lowered. When the opening areas AP3 and AP4 of the first and second pressure dividing valves 35a and 35b become maximum APmax (fully opened), the target control pressures P3tref and P4tref become the tank pressure (zero).

As shown in FIG. 5C, when the LS drive pressure is the tank pressure (zero), the opening areas AP3 and AP4 of the first and second pressure dividing valves 35a and 35b are zero (fully closed), and the target control pressures P3tref and P4tref are equal to the delivery pressures of the third and fourth delivery ports. As a result, when the delivery pressures of the third and fourth delivery ports rise, the target control pressures P3tref and P4tref also rise while remaining equal to the delivery pressures of the third and fourth delivery ports. The gradients of straight lines representing the rates of rise in the target control pressures P3tref and P4tref in this instance are 1. When the delivery pressures of the third and fourth delivery ports reach the set pressures of the first and second relief valves 37a and 37b, the target control pressures P3tref and P4tref become constant at the set pressures of the first and second relief valves 37a and 37b.

When the LS drive pressure rises from the tank pressure, the opening areas AP3 and AP4 of the first and second pressure dividing valves 35a and 35b increase accordingly. As the delivery pressures of the third and fourth delivery ports rise, the target control pressures P3tref and P4tref rise at smaller rates (with smaller gradients of straight lines) as compared to the case where the opening areas AP3 and AP4 of the first and second pressure dividing valves 35a and 35b are zero (fully closed). As the LS drive pressure rises, the rates of rise (gradients of straight lines) in the target control pressures P3tref and P4tref are reduced, and the target control pressures P3tref and P4tref obtained at the same delivery pressures of the third and fourth delivery ports are lowered. When the delivery pressures of the third and fourth delivery ports reach the torque control start pressure Pb which is the set pressure of the first and second relief valves 37a and 37b, the target control pressures P3tref and P4tref become constant at the set pressure (Pb) of the first and second relief valves 37a and 37b.

When the LS drive pressure rises to a predetermined pressure Px2, the opening areas AP3 and AP4 of the first and second pressure dividing valves 35a and 35b become a max APmax (fully opened), and the target control pressures P3tref and P4tref become the tank pressure (zero).

As a result of that the target control pressures P3tref and P4tref thus vary when the delivery pressures of the third and fourth delivery ports rise, the torque control pressures P3t and P4t also vary like the target control pressures P3tref and P4tref, as illustrated in FIG. 5D. Specifically, when the LS drive pressure is the tank pressure (zero), the torque control pressures P3t and P4t are equal to the delivery pressures of the third and fourth delivery ports. As the LS drive pressure rises, the rates of rise (gradients of straight lines) in the torque control pressures P3t and P4t are reduced, and the torque control pressures P3t and P4t obtained at the same delivery pressures of the third and fourth delivery ports are lowered. When the delivery pressures of the third and fourth delivery ports reach the torque control start pressure Pb which is a set pressure of the first and second relief valves 37a and 37b, the torque control pressures P3t and P4t become constant at the set pressure (Pb) of the first and second relief valves 37a and 37b. When the LS drive pressure reaches a predetermined pressure Px2, the torque control pressures P3t and P4t become the tank pressure (zero).

It will be explained below that the torque control pressures P3t and P4t generated by the torque feedback circuit sections 30a and 30b are characteristics simulating the absorption torque of the second hydraulic pump 1b as aforementioned.

In the second pump control unit 5b shown in FIGS. 1A and 1B, assuming that the actual absorption torques of the third and fourth delivery ports P3 and P4 of the second hydraulic pump 1b are τ3 and τ4, the absorption torques τ3 and τ4 are calculated according to the following equations.

τ3=(P3p×q2)/2π (1)

τ4=(P4p×q2)/2π (2)

As aforementioned, P3p and P4p are the delivery pressures of the third and fourth delivery ports P3 and P4, and q2 is the tilting angle of the second hydraulic pump 1b.

In addition, in the case when limitation by the absorption torque constant control (or horsepower constant control) of the second torque control section 13b is not received, the tilting angle of the second hydraulic pump 1 is controlled by the second load sensing control section 12b. In this instance, the swash plate of the second hydraulic pump 1b receives the LS drive pressure Px2 and springs S3 and S4, and the tilting angle q2 is expressed by the following equation.

q2=q2max−K×Px2 (3)

Here, K is a constant determined by the relation between the constants of the springs S3 and S4 and the tilting angle q2 (capacity) of the second hydraulic pump 1b, and is a value corresponding to the gradient K shown in FIG. 3.

On the other hand, in order to cause the torque control pressures P3t and P4t to be characteristics simulating the absorption torque of the second hydraulic pump 1b, it is necessary that biasing forces generated at the first and second torque reduction control pistons 31a and 31b by application of the torque control pressures P3t and P4t should be values proportional to the absorption torques τ3 and τ4 of the third and fourth delivery ports P3 and P4, and for ensuring this, the following relations must be established.

τ3=C(A×P3t) (4)

τ4=C(A×P4t) (5)

Here, A is a pressure-receiving area of the first and second torque reduction control pistons 31a and 31b, and C is a proportionality factor.

From the equations (1) to (5) above, the torque control pressures P3t and P4t are expressed by the following equations.

τ3=(P3p×(q2max−K×Px2))/2π=C(A×P3t)

τ4=(P4p×(q2max−K×Px2))/2π=C(A×P4t)

Deformation of these gives the following equations.

P3t=((P3p×(q2max−K×Px2))/2π)/C×A

P4t=((P4p×(q2max−K×Px2))/2π)/C×A

Substitution D=2π/C×A gives the following equations.

P3t=D(P3p×(q2max−K×Px2)

P4t=D(P4p×(q2max−K×Px2)

Setting the values of A and C such that D×q2max is 1 gives the following equations.

P3t=P3p×(1−(K×Px2/D)) (6)

P4t=P4p×(1−(K×Px2/D)) (7)

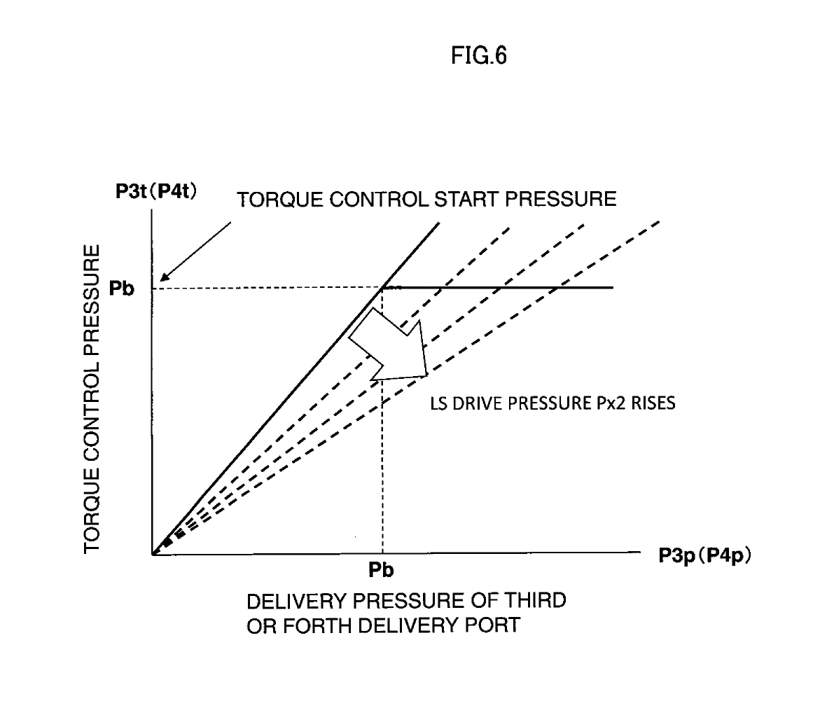

FIG. 6 is a diagram showing relations among the delivery pressures P3p and P4p of the third and fourth delivery ports, the torque control pressures P3t and P4t, and the LS drive pressure Px2 expressed by the equations (6) and (7).

As shown in FIG. 6, when the LS drive pressure Px2 is the tank pressure (zero) in the equations (6) and (7), the torque control pressures P3t and P4t are the same as the delivery pressures P3p and P4p of the third and fourth delivery ports. Besides, as the LS drive pressure Px2 rises, the value of (1−(K×Px2/D)) which is the gradients of straight lines representing the rates of rise in the torque control pressures P3t and P4t is reduced, and the torque control pressures P3t and P4t obtained at the same delivery pressures P3p and P4p of the third and fourth delivery ports are lowered. When the delivery pressures of the third and fourth delivery ports rise to the torque control start pressure Pb, the absorption torque constant control (or horsepower constant control) of the second torque control section 13b is started, and the absorption torque of the second hydraulic pump 1b becomes constant. Therefore, it is sufficient to set the torque control pressures P3t and P4t to be also constant at the torque control start pressure Pb.

As seen from FIGS. 5D and 6, the rates of increase (gradients of straight lines) of the torque control pressures P3t and P4t when the delivery pressures P3p and P4p of the third and fourth delivery ports rise as shown in FIG. 5D vary in such a manner as to be reduced as the LS drive pressure Px3 rises, like the rates of increase (gradients of straight lines) of the torque control pressures P3t and P4t when the delivery pressures P3p and P4p of the third and fourth delivery ports rise as shown in FIG. 6. When the torque control pressures P3t and P4t reach the torque control start pressure Pb which is a set pressure of the first and second relief valves 37a and 37b, the rates of increase (gradients of straight lines) become at the set pressure (Pb).

In this way, the torque control pressures P3t and P4t generated by the torque feedback circuit sections 30a and 30b are characteristics simulating the absorption torque of the second hydraulic pump 1b. The torque feedback circuit sections 30a and 30b have the function of modification, and outputting, the delivery pressure of a main pump 202 in such a manner as to provide characteristics simulating the absorption torque of the main pump 202 both in the cases of when the second hydraulic pump 1b is limited by control of the second torque control section 13b and operates at a maximum torque T2max (second maximum torque) and when the second hydraulic pump 1b is not limited by the second torque control section 13b and the second load sensing control section 12b controls the capacity of the second hydraulic pump 1b (when lower than the start pressure Pb of the absorption torque constant control).

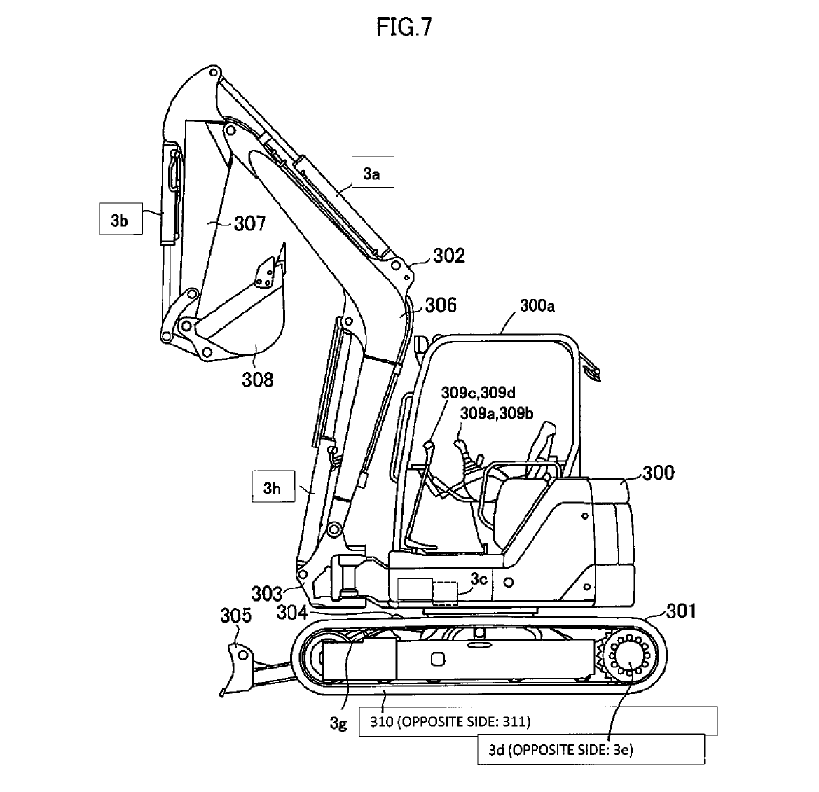

FIG. 7 shows an external appearance of a hydraulic excavator.

In FIG. 7, the hydraulic excavator includes an upper swing structure 300, a lower track structure 301, and a front work device 302. The upper swing structure 300 is swingably mounted on the lower track structure 301, and the front work device 302 is connected to a front end portion of the upper swing structure 300 through a swing post 303 in such a manner as to rotate upward and downward and leftward and rightward. The lower track structure 301 includes left and right crawlers 310 and 311, and is provided on the front side of a track frame 304 with an earth removing blade 305 which is movable up and down. The upper swing structure 300 includes a cabin (operating room) 300a, in which are provided control lever devices 309a and 309b (only one of them is shown) for the front work device and for swing, and control lever/pedal devices 309c and 309d (only one of them is shown) for travelling. The front work device 302 is configured by connecting a boom 306, an arm 307, and a bucket 308 by using pins.

The upper swing structure 300 is driven to swing relative to the lower track structure 301 by a swing motor 3c. The front work device 302 is rotated horizontally by turning a swing post 303 by a swing cylinder 3f (see FIG. 1A). The left and right crawlers 310 and 311 of the lower track structure 301 are driven by left and right travelling motors 3d and 3e. The blade 305 is driven up and down by a blade cylinder 3g. In addition, the boom 306, the arm 307, and the bucket 308 are vertically rotated by extension/contraction of a boom cylinder 3h, an arm cylinder 3a, and a bucket cylinder 3b.

### —Operation—

Operation of this embodiment will be described below.

### <Single Drive>

### <<Single Drive of Actuator on First Hydraulic Pump 1a Side>>

When an arm operation is conducted by singly driving one of actuators connected to the first hydraulic pump 1a side, for example, the arm cylinder 3a, an arm control lever is operated, whereon the flow control valves 6a and 6e are changed over, and hydraulic fluids delivered from the first and second delivery ports P1 and P2 are supplied to the arm cylinder 3a in a joining manner. Besides, in this instance, the delivery flow rates of the first and second delivery ports P1 and P2 are controlled by the load sensing control of the first load sensing control section 12a and the absorption torque constant control of the first torque control section 13a, as aforementioned.

When a bucket operation or a swing operation is conducted by singly driving the bucket cylinder 3b or the swing motor 3c, a relevant control lever is operated, whereon the flow control valve 6b or the flow control valve 6d is changed over, and the hydraulic fluid delivered from the delivery port P1 or P2 on one side is supplied to the bucket cylinder 3b or the swing motor 3c. Besides, in this instance, the delivery flow rates of the first and second delivery ports P1 and P2 are controlled by the load sensing control of the first load sensing control section 12a and the absorption torque constant control of the first torque control section 13a. The hydraulic fluid delivered from the delivery port P2 or P1 on the side of not supplying the hydraulic fluid to the bucket cylinder 3b or the swing motor 3c is returned to the tank by way of the unloading valve 10b or 10a.

### <<Single Drive of Actuator on Second Hydraulic Pump 1b Side>>

When a boom operation is conducted by singly driving one of the actuators connected to the second hydraulic pump 1b side, for example, the boom cylinder 3h, a boom control lever is operated, whereon the flow control valves 6h and 6l are changed over, and hydraulic fluids delivered from the third and fourth delivery ports P3 and P4 are supplied to the boom cylinder 3h in a joining manner. Besides, in this instance, the delivery flow rates of the third and fourth delivery ports P3 and P4 are controlled by the load sensing control of the second load sensing control section 12b and the absorption torque constant control of the second torque control section 13b, as aforementioned.

When a swing operation or a blade operation is performed by singly driving the swing cylinder 3f or the blade cylinder 3g, a relevant control lever is operated, whereon the flow control valve 6i or the flow control valve 6k is changed over, and the hydraulic fluid delivered from the delivery port P3 or P4 on one side is supplied to the swing cylinder 3f or the blade cylinder 3g. Besides, in this instance also, the delivery flow rates of the third and fourth delivery ports P3 and P4 are controlled by the load sensing control of the second load sensing control section 12b and the absorption torque constant control of the second torque control section 13b. The hydraulic fluid delivered from the delivery port P4 or P3 on the side of not supplying the hydraulic fluid to the swing cylinder 3f or the blade cylinder 3g is returned to the tank by way of the unloading valve 10d or 10c.

### <Simultaneous Drive of Actuator on First Hydraulic Pump 1a Side and Actuator on Second Hydraulic Pump 1b Side>

### <<Simultaneous Drive of Arm Cylinder and Boom Cylinder>>

When a combined operation of the arm 307 and the boom 306 is conducted by simultaneously driving the arm cylinder 3a and the boom cylinder 3h, the arm control lever and the boom control lever are operated, whereon the flow control valves 6a and 6e and the flow control valves 6h and 6l are changed over, the hydraulic fluids delivered from the first and second delivery ports P1 and P2 are supplied to the arm cylinder 3a in a joining manner, and the hydraulic fluids delivered from the third and fourth delivery ports P3 and P4 are supplied to the boom cylinder 3h in a joining manner. Besides, on the first hydraulic pump 1a side and the second hydraulic pump 1b side, the delivery flow rates of the first and second delivery ports P1 and P2 and the delivery flow rates of the third and fourth delivery ports P3 and P4 are controlled by the load sensing control of the first and second load sensing control sections 12a and 12b and the absorption torque constant control of the first and second torque control sections 13a and 13b, as aforementioned. In addition, in the absorption torque constant control of the first torque control section 13a, the total torque control shown in FIG. 4A is conducted.

### <<Simultaneous Drive of Swing Arm and Boom Cylinder>>

When a combined operation of the upper swing structure 300 (swing) and the boom 306 by simultaneously driving the swing motor 3c and the boom cylinder 3h, a swing control lever and the boom control lever are operated, whereon the flow control valve 6d and the flow control valves 6h and 6l are changed over, whereon the hydraulic fluid delivered from the second delivery port P2 is supplied to the swing motor 3c, and the hydraulic fluids delivered from the third and fourth delivery ports P3 and P4 are supplied to the boom cylinder 3h in a joining manner. Besides, on the first hydraulic pump 1a side and the second hydraulic pump 1b side, the delivery flow rates of the first and second delivery ports P1 and P2 and the delivery flow rates of the third and fourth delivery ports P3 and P4 are controlled by the load sensing control of the first and second lead sensing control sections 12a and 12b and the absorption torque constant control of the first and second torque control sections 13a and 13b, as aforementioned. In addition, in the absorption torque constant control of the first torque control section 13a, the total torque control shown in FIG. 4A is performed. The hydraulic fluid delivered from the first delivery port P1 on the side where the flow control valves 6a to 6c are closed is returned to the tank by way of the unloading valve 10a.

### <<Simultaneously Drive of Other Combination of Actuator on First Hydraulic Pump 1a Side and Actuator on Second Hydraulic Pump 1b Side>>

In a combined operation other than the above-mentioned in which at least one of the actuators (arm cylinder 3a, bucket cylinder 3b, and swing motor 3c) connected only to the first and second delivery ports P1 and P2 of the first hydraulic pump 1a and at least one of the actuators (swing cylinder 3f, blade cylinder 3g, and boom cylinder 3h) connected only to the third and fourth delivery ports P3 and P4 of the second hydraulic pump 1b are simultaneously driven, also, the delivery flow rates of the first and second delivery ports P1 and P2 and the delivery flow rates of the third and fourth delivery ports P3 and P4 are controlled by the load sensing control and the absorption torque constant control, similarly to the above. Besides, in the absorption torque constant control of the first torque control section 13a, the total torque control shown in FIG. 4A is conducted. The hydraulic fluid delivered from the delivery port on the side where the flow control valve is closed is returned to the tank by way of the unloading valve.

### <Simultaneous Drive of Two Actuators on First Hydraulic Pump 1a Side>

In a combined operation in which at least one of the actuators (arm cylinder 3a, bucket cylinder 3b, and travelling-right travelling motor 3e) connected to the first delivery port P1 of the first hydraulic pump 1a and at least one of the actuators (arm cylinder 3a, swing motor 3c, and travelling-left travelling motor 3d) connected to the second delivery port P2 of the first hydraulic pump 1b are simultaneously driven, the delivery flow rates of the first and second delivery ports P1 and P2 are controlled by the load sensing control of the first load sensing control section 12a and the absorption torque constant control of the first torque control section 13a, like in the case of the arm operation in which the arm cylinder 3a is singly driven. In addition, a surplus flow rate of the hydraulic fluid delivered from the delivery port on the side where the demanded flow rate is low or the hydraulic fluid delivered from the delivery port on the side where the flow control valve is closed is returned to the tank by way of the unloading valve. In this instance, a load pressure (maximum load pressure) of the actuators on the first delivery port P1 side that is detected by the first shuttle valve group 208a is introduced to the pressure compensating valves 7a to 7c and the first unloading valve 210a, whereas a load pressure (maximum load pressure) of the actuators on the second delivery port P2 side that is detected by the second shuttle valve group 208b is introduced to the pressure compensating valves 7d to 7f and the second unloading valve 210b, and controls by the pressure compensating valves and the unloading valve are performed separately on the first delivery port P1 side and on the second delivery port P2 side. This ensures that when the surplus flow rate of the delivery port on the low load pressure side is returned to the tank, the pressure of the delivery port is limited in rise based on the low load pressure by the unloading valve on the relevant delivery port side, and, accordingly, the pressure loss at the unloading valve at the time of returning of the surplus flow rate to the tank is reduced, and an operation with little energy loss can be achieved.

### <Simultaneous Drive of Two Actuators on Second Hydraulic Pump 1b Side>

In a combined operation in which two actuators on the second hydraulic pump 1b side are simultaneously driven, also, the delivery flow rates of the third and fourth delivery ports P3 and P4 are controlled by the load sensing control of the second load sensing control section 12b and the second torque control section 13b, like in the aforementioned case of the combined operation in which two actuators on the first hydraulic pump 1a are simultaneously driven. In addition, a surplus flow rate of hydraulic fluid delivered from the delivery port on the side where the demanded flow rate is low or the hydraulic fluid delivered from the delivery port on the side where the flow control valve is closed is returned to the tank by way of the unloading valve, and, accordingly, the pressure loss at the unloading valve in this instance is reduced, and an operation with little energy loss can be achieved.

### <Travelling Operation>

When a travelling operation is conducted by driving the travelling-left travelling motor 3d and the travelling-right travelling motor 3e, left and right travelling control levers or pedals are operated, whereon the flow control valves 6f and 6j and the flow control valves 6c and 6g are changed over, whereby the hydraulic fluid delivered from the second delivery port P2 of the first hydraulic pump 1a and the hydraulic fluid delivered from the fourth delivery port P4 of the second hydraulic pump 1b are supplied to the travelling-left travelling motor 3d in a joining manner, whereas the hydraulic fluid delivered from the first delivery port P1 of the first hydraulic pump 1a and the hydraulic fluid delivered from the third delivery port P3 of the second hydraulic pump 1b are supplied to the travelling-right travelling motor 3e in a joining manner. Therefore, even if the tilting angle of the swash plate of the first hydraulic pump 1a and the tilting angle of the swash plate of the second hydraulic pump 1b are different and a difference in delivery flow rate is generated between the first and second delivery ports P1 and P2 and the third and fourth delivery ports P3 and P4, the supply flow rate to the travelling-left travelling motor 3d and the supply flow rate to the travelling-right travelling motor 3e are the same, and, accordingly, the vehicle body can travel straight without meandering.

Specifically, assuming that the delivery flow rate of the first delivery port P1 is Q1, the delivery flow rate of the second delivery port P2 is Q2, the delivery flow rate of the third delivery port P3 is Q3, and the delivery flow rate of the fourth delivery port P4 is Q4, then the supply flow rate to the travelling-left travelling motor 3d and the supply flow rate to the travelling-right travelling motor 3e are as follows.

Travelling-left supply flow rate: Q2+Q4

Travelling-right supply flow rate: Q1+Q3

Here, the relations of Q1=Q2 (because of the same swash plate) and Q3=Q4 (because of the same swash plate) are established. Therefore, even if Q1=Q2≠Q3=Q4, the relation of

Q2+Q4=Q1+Q3

is established, and, therefore, the supply flow rate to the travelling-left travelling motor 3d and the supply flow rate to the travelling-right travelling motor 3e are the same.

In this way, even if a difference in delivery flow rate is generated between the first and second delivery ports P1 and P2 and the third and fourth delivery ports P3 and P4, the supply flow rate to the travelling-left travelling motor 3d and the supply flow rate to the travelling-right travelling motor 3e are the same, and, accordingly, the vehicle body can travel straight without meandering.

### <Travelling Combined Operation>

A case of performing a travelling combined operation in which the travelling motors 3d and 3e and at least one of other actuators, for example, the arm cylinder 3a are simultaneously driven will be described.

When the left and right travelling control levers or pedals and the arm control lever are operated with an intention to perform a travelling combined operation, the flow control valves 6f and 6j, the flow control valves 6c and 6g and the flow control valves 6a and 6e are changed over, and, simultaneously, the first communication control valve 215a is changed over to the communication position of the lower side in the drawing. With such arrangement, the hydraulic fluids delivered from the first and second delivery ports P1 and P2 are supplied from the first hydraulic pump 1a side in a joining manner and the hydraulic fluid delivered from the fourth delivery port P4 is supplied from the secondary hydraulic pump 1b side, to the travelling-left travelling motor 3d, whereas the hydraulic fluids delivered from the first and second delivery ports P1 and P2 are supplied from the first hydraulic pump 1a side in a joining manner and the hydraulic fluid delivered from the third delivery port P3 is supplied from the second hydraulic pump 1b side, to the travelling-right travelling motor 3e. The arm cylinder 3a is supplied with the remainder of the hydraulic fluids supplied to the travelling motors 3d and 3e from the first and second delivery ports P1 and P2.

In this instance, besides, on the first hydraulic pump 1a side, the first communication control valve 215a is changed over to the communication position of the lower side in the drawing. Therefore, the maximum load pressure of the actuators 3a to 3e that is detected by the first and second shuttle valve groups 208a and 208b is introduced to the load sensing control valves 216a and 216b, the pressure compensating valves 7a to 7c and 7d to 7f and the first unloading valves 210a and 210b, whereby the load sensing control and the controls of the pressure compensating valves and the unloading valves are performed. On the other hand, on the second hydraulic pump 1b side, the second communication control valve 215b is held in the interruption position of the upper side in the drawing. Therefore, the maximum load pressures are detected separately on the third delivery port P3 side and on the fourth delivery port P4 side, and the respective maximum load pressures are introduced to the load sensing control valves 216c and 216d, the pressure compensating valves 7g to 7i and 7j to 7m and the third and fourth unloading valves 210c and 210d, whereby the load sensing control and the controls of the pressure compensating valves and the unloading valves are performed.

Here, a case where straight travelling is conducted by a travelling combined operation will be described.

When the left and right travelling control levers or pedals are operated by the same amount with the intention to perform straight travelling by a travelling combined operation, the flow control valves are changed over such that the stroke amount (opening area) of the flow control valves 6f and 6j and the stroke amount (opening area−demanded flow rate) of the flow control valves 6c and 6g will be the same. In addition, as aforementioned, the hydraulic fluid delivered from the second delivery port P2 of the first hydraulic pump 1a and the hydraulic fluid delivered from the fourth delivery port P4 of the second hydraulic pump 1b are supplied to the travelling-left travelling motor 3d in a joining manner; the hydraulic fluids delivered from the first and second delivery ports P1 and P2 are supplied from the first hydraulic pump 1a side in a joining manner and the hydraulic fluid delivered from the fourth delivery port P4 is supplied from the second hydraulic pump 1b side, to the travelling-left travelling motor 3d; the hydraulic fluids delivered from the first and second delivery ports P1 and P2 are supplied from the first hydraulic pump 1a side in a joining manner and the hydraulic fluid delivered from the third delivery port P3 is supplied from the second hydraulic pump 1b side, to the travelling-right travelling motor 3e. This ensures that in the travelling combined operation, also, the supply flow rate to the travelling-left travelling motor 3d and the supply flow rate to the travelling-right travelling motor 3e are the same, and, therefore, the vehicle body can travel straight without meandering.

Specifically, assuming that the delivery flow rate of the first delivery port P1 is Q1, the delivery flow rate of the second delivery port P2 is Q2, the delivery flow rate of the third delivery port P3 is Q3, and the delivery flow rate of the fourth delivery port P4 is Q4, and that the flow rate of the hydraulic fluid supplied to the travelling-left travelling motor 3d is Qd, the flow rate of the hydraulic fluid supplied to the travelling-right travelling motor 3e is Qe, and the flow rate of the hydraulic fluid supplied to the boom cylinder 3a which is an actuator other than the travelling motors is Qa, the flow rates Qd and Qe of the hydraulic fluids supplied to the left and right travelling motors 3d and 3e are as follows.

First, each of the left and right travelling motor 3d and 3e is supplied with hydraulic fluid from the first hydraulic pump 1a side in an amount of ½ of Q1+Q2−Qa, the amount obtained by subtracting the flow rate Qa of the hydraulic fluid supplied to the boom cylinder 3a from the total flow rate Q1+Q2 of the hydraulic fluids delivered from the first and second deliver ports P1 and P2. The amount supplied is ½ of Q1+Q2−Qa because the stroke amount (opening area) of the flow control valve 6f and the stroke amount (opening area−demanded flow rate) of the flow control valve 6c are the same. In addition, each of the left and right travelling motors 3d and 3e is supplied with hydraulic fluid from the second hydraulic pump 1b side in an amount of ½ of the total flow rate Q3+Q4 of the hydraulic fluids delivered from the first and second delivery ports P1 and P2. In this case, also, the amount supplies is ½ of Q3+Q4 because the stroke amount (opening area) of the flow control valve 6j and the stroke amount (opening area−demanded flow rate) of the flow control valve 6g are the same. Accordingly, the flow rates Qd and Qe of the hydraulic fluids supplied to the left and right travelling motors 3d and 3e are expressed as follows.

Travelling-right supply flow rate Qd=(Q1+Q2−Qa)/2+(Q3+Q4)/2

Travelling-left supply flow rate Qe=(Q1+Q2−Qa)/2+(Q3+Q4)/2

In other words, Qd=Qe, and according, the vehicle body can travel straight without meandering.

The above-mentioned example of the travelling combined operation corresponds to the case where the travelling motors 3d and 3e and the arm cylinder 3a are simultaneously driven. As other example of the travelling combined operation, there is a travelling combined operation in which an actuator (bucket cylinder 3b, swing motor 3c) driven by the hydraulic fluid delivered only from the first delivery port P1 or the second delivery port P2 of the first hydraulic pump 1a or an actuator (swing cylinder 3f, blade cylinder 3g) driven by the hydraulic fluid delivered only from the third delivery port P3 or the fourth delivery port P4 of the second hydraulic pump 1b is driven simultaneously with the travelling motors. In this embodiment, in the case of performing such a travelling combined operation, also, the vehicle body can travel straight without meandering.

Note that in this embodiment, the first to fourth shuttle valve groups 208a to 208d, the first and second communication control valves 15a and 15b, the load sensing control valves 216a to 216d and the low pressure selection valves 221a and 221b are provided, and communication is established and interrupted with respect to both the delivery ports and the output hydraulic line of the maximum load pressure by the first and second communication control valves 15a and 15b. However, a structure in which communication is established and interrupted with respect to the delivery ports by the first and second communication control valves 15a and 15b may be adopted, and the other circuit structure may be the same as in the first embodiment. In this case, also, the first and second communication control valves 15a and 15b are changed over to the communication positions at the time of the travelling combined operation, whereby an effect to secure the straight travelling properties can be obtained.

### —Effect—

The effects obtained by this embodiment will be described below.

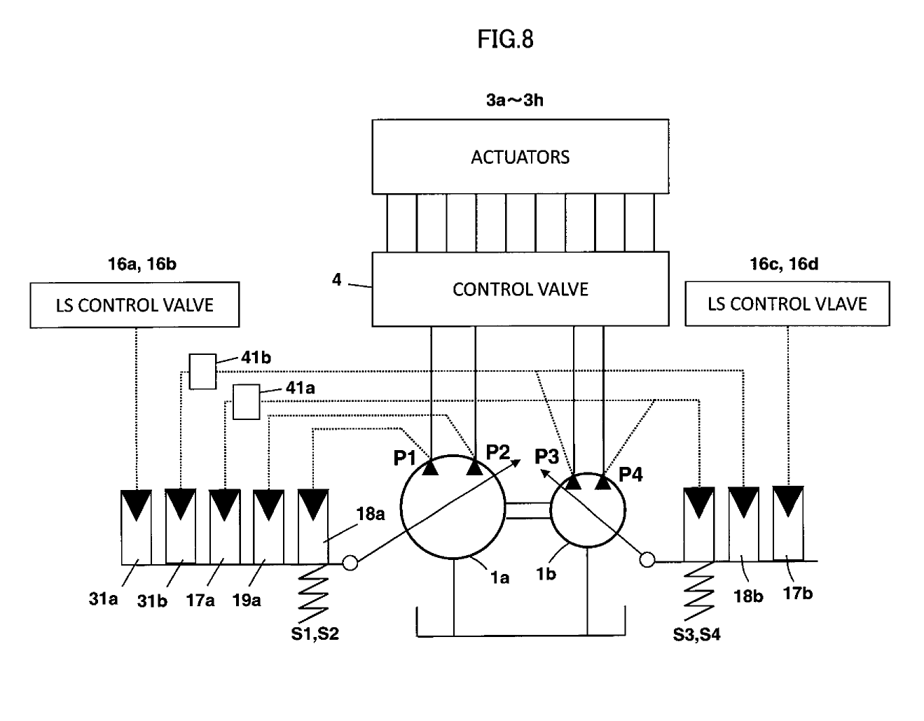

FIG. 8 is a diagram showing, as a comparative example, a hydraulic system in the case where the total torque control technology described in Patent Document 2 is incorporated into the two-pump load sensing system provided with the first and second hydraulic pumps 1a and 1b shown in FIG. 1. In the diagram, members equivalent to the elements shown in FIG. 1 are denoted by the same reference symbols as used above.

The hydraulic system of the comparative example shown in FIG. 8 includes pressure reduction valves 41a and 41b in place of the torque feedback circuit 30 (the first torque feedback circuit section 30a and the second torque feedback circuit section 30b). The pressure reduction valves 41a and 41b reduce the delivery pressures of the third and fourth delivery ports of the second hydraulic pump 1b in such a manner that the secondary pressures (torque control pressures) does not exceed a set pressure, and outputs the thus reduced pressures. The set pressure of the pressure reduction valves 41a and 41b is set to be a value (the start pressure Pb of the absorption torque constant control shown in FIG. 4B) corresponding to the maximum torque T2max set by the springs S3 and S4 in the torque control section of the second hydraulic pump 1b.

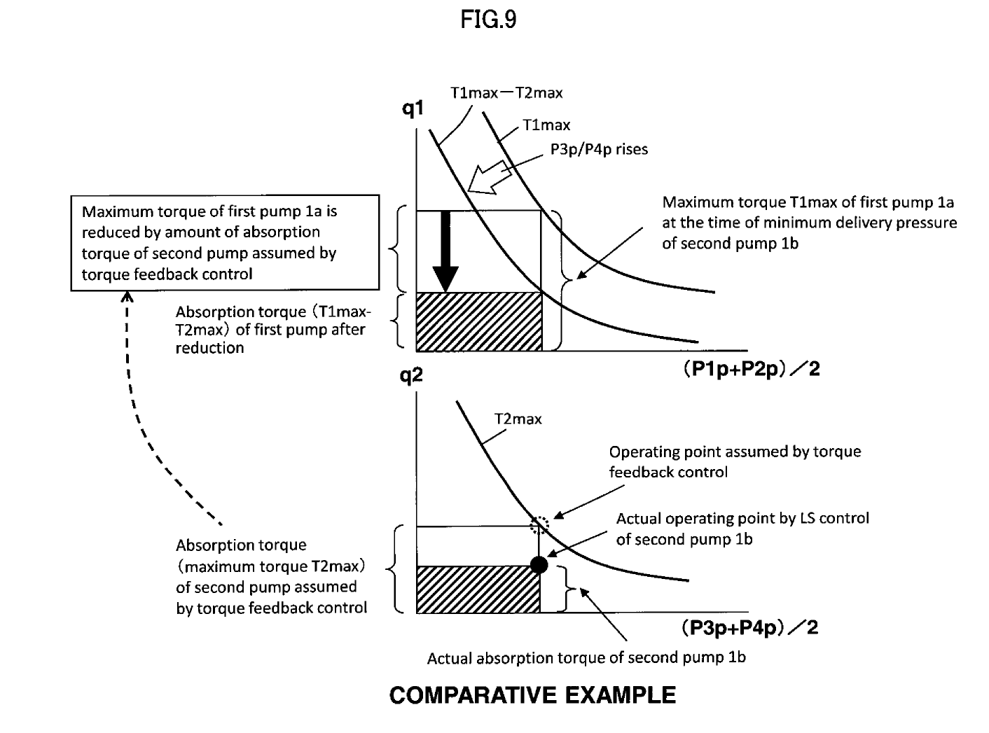

FIG. 9 is a diagram showing the total torque control in the comparative example shown in FIG. 8. In the comparative example illustrated in FIG. 8, when the delivery pressures of the third and fourth delivery ports of the second hydraulic pump are equal to or higher than the start pressure of the absorption torque constant control, it is assumed that the second hydraulic pump 1b is under the absorption torque constant control. In this case, the pressure reduction valves 41a and 41b reduce the delivery pressures of the third and fourth delivery ports of the second hydraulic pump to a pressure corresponding to the maximum torque T2max, and introduce the thus reduced pressure to the torque reduction control pistons 31a and 31b of the first hydraulic pump 1a. On the first hydraulic pump 1a side, the maximum torque is reduced from T1max by an amount of T2max. In this way, the total torque control is carried out.

However, even when the delivery pressures of the third and fourth delivery ports of the second hydraulic pump are equal to or higher than the start pressure of the absorption torque constant control, there is a case where the second hydraulic pump 1b is not under the absorption torque constant control, and the second hydraulic pump 1b is controlled to a tilting angle smaller than the tilting that is limited under the absorption torque constant control by the load sensing control. In this case, the absorption torque of the second hydraulic pump 1b estimated with the pressure corresponding to the maximum torque T2max would be a value greater than the actual absorption torque of the second hydraulic pump 1b.

As a result, in the first hydraulic pump 1a where a pressure corresponding to the maximum torque T2max is introduced and the total torque control is conducted with the maximum torque of T1max−T2max, such a control as to reduce the maximum torque more than necessary would be performed, and, accordingly, the output torque of the prime mover cannot be used effectively.

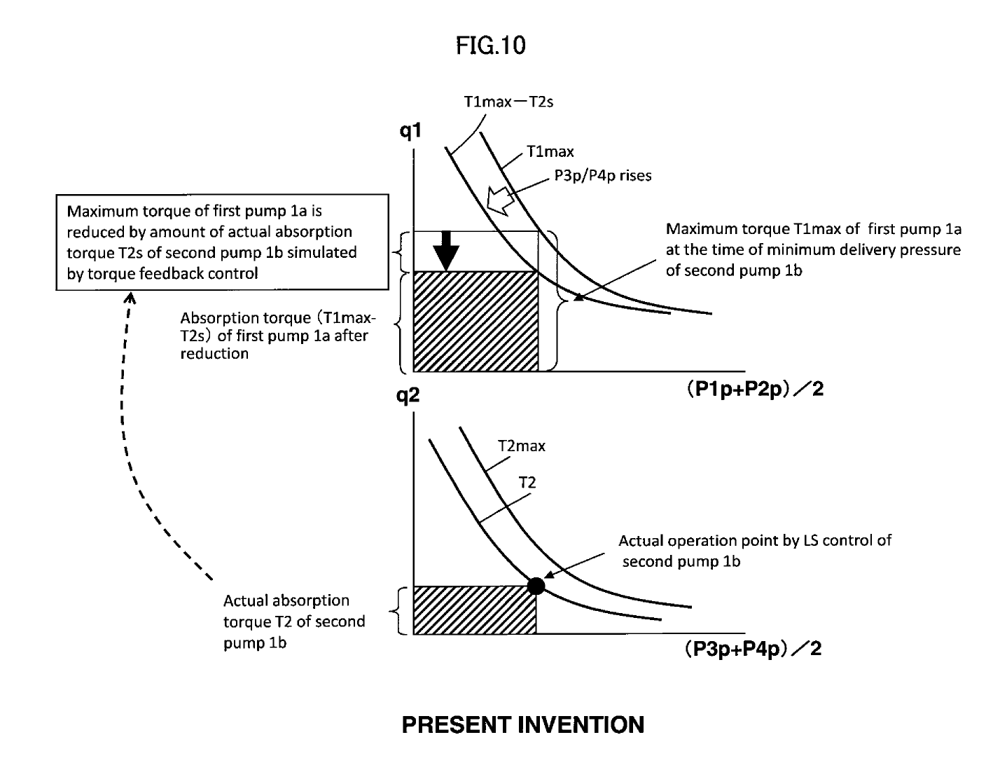

FIG. 10 is a diagram showing a total torque control in this embodiment.

In this embodiment, the torque feedback circuit 30 modifies the delivery pressures of the third and fourth delivery ports P3 and P4 of the second hydraulic pump 1b in such a manner as to provide characteristics simulating the absorption torque of the second hydraulic pump 1b both in the cases of when the second hydraulic pump 1b is limited by control of the second torque control section 13b and operates at the maximum torque T2max (second maximum torque) and when the second hydraulic pump 1b is not limited by the control of the second torque control section 13b and the second load sensing control section 12b controls the capacity of the second hydraulic pump 1b (when lower than the start pressure Pb of the absorption torque constant control of the second hydraulic pump 1b), and outputs the thus modified pressures. The first and second torque reduction control pistons 31a and 31b reduce the maximum torque T1max set in the first torque control section 13a, as the output pressure of the torque feedback circuit 30 becomes higher.

For example, as aforementioned, when the delivery pressures of the third and fourth delivery ports P3 and P4 of the second hydraulic pump 1b rise, the absorption torque of the second hydraulic pump 1b in that instance is T2 which is lower than the maximum torque T2max, and the absorption torque simulated by the torque feedback circuit 30 is T2s (≈T2), the torque feedback pistons 32a and 32b reduce the maximum torque T1max to T1max−T2s, as shown in FIG. 10, and the total torque control is conducted with the maximum torque T1max−T2s. As a result, the maximum torque is not reduced more than necessary, and stoppage of the engine 2 (engine stall) can be prevented, while making the most of the rated output torque TER of the engine 2.

As above-mentioned, according to this embodiment, the absorption torque of the second hydraulic pump 1b can be accurately detected by a purely hydraulic structure (torque feedback circuit 30). In addition, by feeding back the absorption torque to the first hydraulic pump 1a side, it is possible to accurately perform the total torque control and to effectively utilize the rated output torque TER of the prime mover 2. Besides, owing to the structure in which the absorption torque of the second hydraulic pump 1b is detected on a purely hydraulic basis, the first pump control unit 5a can be miniaturized, and the mountability of the hydraulic pump inclusive of the pump control unit is enhanced. Consequently, it is possible to provide a construction machine that is good in energy efficiency, is low in fuel cost, and is practical.

In addition, as shown in FIGS. 5C and 5D, the target control pressures formed in the first and second hydraulic lines 36a and 36b between the first and second pressure dividing restrictor parts (fixed restrictors) 34a and 34b and the first and second pressure dividing valves (variable restrictor valves) 35a and 35b and the torque control pressures outputted by the first and second pressure reduction valves 32a and 32b are pressures of the same values, and the pressures formed in the first and second hydraulic lines 36a and 36b can also be used directly as torque control pressures.

In the case where the pressures formed in the first and second hydraulic lines 36a and 36b are used directly as the torque control pressures, however, at the time of driving the third torque control actuators 32a and 32b with the torque control pressures, the first and second pressure dividing restrictor parts (fixed restrictors) 34a and 34b constitute resistances to make it difficult to supply sufficient quantities of hydraulic fluid to the third torque control actuators 32a and 32b, so that the responsiveness of the third torque control actuators 32a and 32b may be worsened.

Besides, in the case where hydraulic fluid is supplied from the first and second hydraulic lines 36a and 36b to the third torque control actuators 32a and 32b, pressure variations are liable to occur due to variations in the quantities of hydraulic fluid in the first and second hydraulic lines 36a and 36b, making it difficult for the pressures formed in the first and second hydraulic lines 36a and 36b to be accurately set to attain pressure variations as shown in FIG. 5C. Further, when the delivery pressure of the second hydraulic pump 1b fluctuates, the fluctuations in the delivery pressure may be transmitted directly to the third torque control actuators 32a and 32b, whereby stability of the system may be damaged.

In this embodiment, the pressures in the first and second hydraulic lines 36a and 36b between the first and second pressure dividing restrictor parts (fixed restrictors) 34a and 34b and the first and second pressure dividing valves (variable restrictor valves) 35a and 35b are introduced to the first and second pressure reduction valves 32a and 32b as target control pressures, thereby providing the set pressures for the first and second pressure reduction valves 32a and 32b, and the torque control pressure is generated from the delivery pressure of the second hydraulic pump 1b by the first and second pressure reduction valves 32a and 32b. Therefore, it is possible to secure the flow rates at the time of driving the third torque control actuators 32a and 32b with the torque control pressure, and to obtain good responsiveness at the time of driving the third torque control actuators 32a and 32b.

In addition, since the pressures in the first and second hydraulic lines 36a and 36b between the first and second pressure dividing restrictor parts (fixed restrictors) 34a and 34b and the first and twenty-second pressure dividing valves (variable restrictor valves) 35a and 35b are not used directly as the torque control pressures, the setting of the first and second pressure dividing restrictor parts (fixed restrictors) 34a and 34b and the first and twenty-second pressure dividing valves (variable restrictor valves) 35a and 35b for obtaining the required target control pressures and the setting of the responsiveness of the third torque control actuators 32a and 32b can be performed independently, so that the setting of the torque feedback circuit 30 for exhibiting required performance can be performed easily and accurately.

Further, when the delivery pressure of the second hydraulic pump 1b is higher than the set pressures of the first and second pressure reduction valves 32a and 32b, fluctuations in the delivery pressure of the second hydraulic pump 1b is blocked by the first and second pressure reduction valves 32a and 32b, and therefore do not influence the third torque control actuators 32a and 32b. Accordingly, the stability of the system is secured.

### OTHERS

While the case where the first and second hydraulic pumps are split flow type hydraulic pumps having the first and second delivery ports P1 and P2 and the third and fourth delivery ports P3 and P4, respectively, has been described in the embodiment above, both or one of the first and second hydraulic pumps may be a single flow type hydraulic pump having a single delivery port. In the case where the first and second hydraulic pumps are single flow type hydraulic pumps, it is sufficient that the torque feedback circuit 30 has one circuit section and one torque reduction control piston to which the torque control pressure is introduced. Besides, the axis of abscissas in FIGS. 4A and 4B then represents the pressure of the single delivery port (the delivery pressure of the hydraulic pump).

In addition, since in the torque feedback circuit 30 the target control pressures formed in the first and second hydraulic lines 36a and 36b between the first and second pressure dividing restrictor parts (fixed restrictors) 34a and 34b and the first and second pressure dividing valves (variable restrictor valves) 35a and 35b and the torque control pressures outputted by the first and second pressure reduction valves 32a and 32b are pressures of the same values as aforementioned, a structure may be adopted in which the pressures formed in the first and second hydraulic lines 36a and 36b are introduced directly to the torque reduction control actuators 31a and 31b as torque control pressures.

Besides, while in the embodiment above the first and second relief valves 37a and 37b have been provided in the torque feedback circuit 30 in such a manner that the pressures in the first and second hydraulic lines 36a and 36b between the first and second pressure dividing restrictor parts (fixed restrictors) 34a and 34b and the first and second pressure dividing valves (variable restrictor valves) 35a and 35b do not increase beyond the set pressure (torque start pressure Pb), pressure reduction valves may be used in place of the relief valves. In this case, by providing the set pressure of the pressure reduction valves at the torque start pressure Pb and using the output pressures of the pressure reduction valves as the target control pressures P35ref and P4tref, the same or similar function to the above can be obtained.

In addition, while the first pump control unit 5a has had the first load sensing control section 12a and the first torque control section 18a, the first load sensing control section 12a in the first pump control unit 5a is not indispensable, and other control system, such as the so-called positive control or negative control system may also be used so long as the system can control the capacity of the first hydraulic pump according to the operation amount of the control lever (flow control valve's opening area−demanded flow rate).

Further, the load sensing system in the embodiment above is an example, and the load sensing system may be modified variously. For instance, while the differential pressure reduction valve outputting the pump delivery pressure and the maximum load pressure as absolute pressures has been provided and its output pressure has been introduced to the pressure compensating valve to set the target compensating pressure and introduced to the LS control valve to set the target differential pressure for the load sensing control in the embodiment above, the pump delivery pressure and the maximum load pressure may be introduced to the pressure control valve and the LS control valve by way of different hydraulic lines.

### DESCRIPTION OF REFERENCE CHARACTERS

1a: First hydraulic pump
1b: Second hydraulic pump
2: Prime mover (diesel engine)
3a-3h: Actuators
3a: Arm cylinder
3d: Left travelling motor
3e: Right travelling motor
3h: Boom cylinder
4: Control valve
5a: First pump control unit
5b: Second pump control unit
6a-6m: Flow control valves
7a-7m: Pressure compensating valves
8a: First shuttle valve group
8b: Second shuttle valve group
8c: Third shuttle valve group
8d: Fourth shuttle valve group
9a-9d: Springs
10a-10d: Unloading valves
12a: First load sensing control section
12b: Second load sensing control section
13a: First torque control section
13b: Second torque control section
15a: First communication control valve
15b: Second communication control valve
16a-16d: Load sensing control valves
17a, 17b: Load sensing control pistons (load sensing control actuators)
18a: First torque control piston (first torque control actuator)
19a: Second torque control piston (first torque control actuator)
18b: Third torque control piston (second torque control actuator)
19b: Fourth torque control piston (second torque control actuator)
21a, 21b: Low pressure selection valves
30: Torque feedback circuit
30a: First torque feedback circuit section
30b: Second torque feedback circuit section
31a: First torque reduction control piston (third torque control actuator)
31b: Second torque reduction control piston (third torque control actuator)
32a: First torque pressure reduction valve
32b: Second torque pressure reduction valve
33a: First pressure dividing circuit
33b: Second pressure dividing circuit
34a: First pressure dividing restrictor part
34b: Second pressure dividing restrictor part
35a: First pressure dividing valve
35b: First pressure dividing valve
36a: First hydraulic line
36b: Second hydraulic line
37a: First relief valve (pressure limiting valve)
37b: Second relief valve (pressure limiting valve)
P1, P2: First and second delivery ports
P3, P4: Third and Fourth delivery ports
S1, S2: Springs
S3, S4: Springs

1. A hydraulic drive system for a construction machine, comprising:
a prime mover;
a variable displacement first hydraulic pump driven by the prime mover;
a variable displacement second hydraulic pump driven by the prime mover;
a plurality of actuators driven by hydraulic fluids delivered by the first and second hydraulic pumps;
a plurality of flow control valves that control flow rates of hydraulic fluids supplied from the first and second hydraulic pumps to the plurality of actuators;
a plurality of pressure compensating valves that control differential pressures across the plurality of flow control valves;
a first pump control unit that controls a delivery flow rate of the first hydraulic pump; and
a second pump control unit that controls a delivery flow rate of the second hydraulic pump,
the first pump control unit including
a first torque control section that, when at least one of delivery pressure and capacity of the first hydraulic pump increases and absorption torque of the first hydraulic pump increases, controls the capacity of the first hydraulic pump such that the absorption torque of the first hydraulic pump does not exceed a first maximum torque,
the second pump control unit including
a second torque control section that, when at least one of delivery pressure and capacity of the second hydraulic pump increases and absorption torque of the second hydraulic pump increases, controls the capacity of the second hydraulic pump such that the absorption torque of the second hydraulic pump does not exceed a second maximum torque, and
a load sensing control section that, when the absorption torque of the second hydraulic pump is lower than the second maximum torque, controls the capacity of the second hydraulic pump such that the delivery pressure of the second hydraulic pump becomes higher by a target differential pressure than a maximum load pressure of the actuators driven by a hydraulic fluid delivered by the second hydraulic pump,
wherein the first torque control section includes a first torque control actuator that receives the delivery pressure of the first hydraulic pump and, when the delivery pressure rises, controls the capacity of the first hydraulic pump to decrease the capacity of the second hydraulic pump and decrease the absorption torque thereof, and first biasing means that sets the first maximum torque,
the second torque control section includes a second torque actuator that receives the delivery pressure of the second hydraulic pump and, when the delivery pressure rises, controls the capacity of the second hydraulic pump to decrease the capacity of the second hydraulic pump and decrease the absorption torque thereof, and second biasing means that sets the second maximum torque,
the load sensing control section includes
a control valve that varies a load sensing drive pressure such that the load sensing drive pressure is lowered as a differential pressure between the delivery pressure of the second hydraulic pump and the maximum load pressure becomes smaller than the target differential pressure, and a load sensing control actuator that controls the capacity of the second hydraulic pump to increase the capacity of the second hydraulic pump and increase the delivery flow rate as the load sensing drive pressure becomes lower,
the first pump control unit further includes
a torque feedback circuit that receives the delivery pressure of the second hydraulic pump and the load sensing drive pressure and modifies the delivery pressure of the second hydraulic pump based on the delivery pressure of the second hydraulic pump and the load sensing drive pressure to provide a characteristic simulating the absorption torque of the second hydraulic pump both in the cases of when the second hydraulic pump is limited by control of the second torque control section and operates at the second maximum torque and when the second hydraulic pump is not limited by control of the second torque control section and the load sensing control section controls the capacity of the second hydraulic pump, and then outputs the modified delivery pressure as a torque control pressure, and
a third torque control actuator that receives the torque control pressure and controls the capacity of the first hydraulic pump to decrease the capacity of the first hydraulic pump and decrease the first maximum torque as the torque control pressure becomes higher,
the torque feedback circuit includes
a fixed restrictor that receives the delivery pressure of the second hydraulic pump,
a variable restrictor valve located in a downstream side of the fixed restrictor and connected to a tank in the downstream side thereof, and
a pressure limiting valve connected to a hydraulic line between the fixed restrictor and the variable restrictor valve to control the pressure in the hydraulic line such that the pressure does not increase beyond a pressure that initiates the control of the second torque control section,
the variable restrictor valve is configured such that the variable restrictor valve is fully closed when the load sensing drive pressure is at a lowest pressure and that the opening area of the variable restrictor valve increases as the load sensing drive pressure rises, and
the torque feedback circuit generates the torque control pressure based on the pressure in the hydraulic line between the fixed restrictor and the variable restrictor valve, the torque control pressure being introduced to the third torque control actuator.

2. The hydraulic drive system for a construction machine according to claim 1,
wherein the torque feedback circuit further includes a pressure reduction valve that receives the delivery pressure of the second hydraulic pump as a primary pressure,
the pressure in the hydraulic line between the fixed restrictor and the variable restrictor valve is introduced to the pressure reduction valve as a target control pressure for providing a set pressure of the pressure reduction valve, and
the pressure reduction valve outputs the delivery pressure of the secondary hydraulic pump as a secondary pressure without reduction when the delivery pressure of the second hydraulic pump is lower than the set pressure, and reduces the delivery pressure of the second hydraulic pump to the set pressure and outputs the thus lowered pressure when the delivery pressure of the second hydraulic pump is higher than the set pressure, the output pressure of the pressure reduction valve being introduced to the third torque control actuator as the torque control pressure.

3. The hydraulic drive system for a construction machine according to claim 2,
wherein the pressure limiting valve is a relief valve.

4. The hydraulic drive system for a construction machine according to claim 2,
wherein the pressure limiting valve is a relief valve.
